(19) United States
(12) Patent Application Publication
(10) Pub. No.: US 2026/0018063 A1
(43) Pub. Date: Jan. 15, 2026

(54) TRAVEL SUPPORT DEVICE, TRAVEL SUPPORT METHOD, AND NON-TRANSITORY COMPUTER-READABLE RECORDING MEDIUM

(71) Applicants: TOYOTA JIDOSHA KABUSHIKI KAISHA, Toyota-shi (JP); DENSO CORPORATION, Kariya-city (JP)

(72) Inventors: Soichi YOSHINO, Ichikawa-shi (JP); Ryuta HASHIMOTO, Tokyo-to (JP); Takahiro SETA, Yokohama-shi (JP); Takuo KANEKO, Tokyo-to (JP)

(73) Assignees: TOYOTA JIDOSHA KABUSHIKI KAISHA, Toyota-shi (JP); DENSO CORPORATION, Kariya-city (JP)

(21) Appl. No.: 19/238,761

(22) Filed: Jun. 16, 2025

(30) Foreign Application Priority Data
Jul. 9, 2024 (JP) 2024-110347

(51) Int. Cl. G08G 1/00; G06Q 30/04

(52) U.S. Cl. CPC G08G 1/22; G06Q 30/04; G06Q 2240/00

(57) ABSTRACT

A travel support device supports platooning of a plurality of vehicles. The travel support device includes one or more processors configured to: acquire travel preference information indicating a preference of an occupant regarding vehicle traveling, from each of the plurality of vehicles; based on the travel preference information, execute vehicle train formation support processing of supporting formation of a support target vehicle train in which vehicles having similar preferences perform the platooning; and when there is a plurality of support target vehicle trains, execute first travel control processing of acquiring at least one of the travel preference information and vehicle train travel information from each of the plurality of support target vehicle trains and controlling the platooning of each of the plurality of support target vehicle trains based on the acquired at least one of the travel preference information and the vehicle train travel information.

### CROSS-REFERENCES TO RELATED APPLICATION

The present disclosure claims priority under 35 U.S.C. § 119 to Japanese Patent Application No. 2024-110347, filed on Jul. 9, 2024, which is incorporated herein by reference in its entirety.

### BACKGROUND

### Technical Field

The present disclosure relates to a technique that supports platooning of a plurality of vehicles.

### Background Art

JP 2020-042649 A discloses a driving assistance device that helps vehicles merge into a vehicle group including a plurality of vehicles traveling in a row.

JP 2023-097153 A discloses a vehicle management device. When determining that a convoy is divided, the vehicle management device decelerates a convoy traveling ahead until another convoy traveling behind among the divided convoys merges into the convoy traveling ahead. Moreover, when a convoy is divided, the vehicle management device determines whether or not a distance between the divided convoys is equal to or longer than a predetermined distance, and manages the divided convoys as separate convoys when the distance is equal to or longer than the predetermined distance.

JP 2014-078170 A discloses a convoy travel system. If a travel lane of a convoy is a lane adjacent to a merging point when the convoy is determined to have approached the merging point, the convoy travel system causes only some of the vehicles forming the convoy to perform a lane change to a lane on the opposite side to the side where the merging point is present. Further, JP 2023-037371 A discloses a power supply system that contributes to expanding the application of convoy travel by proving an incentive to a vehicle to travel as the lead vehicle of the convoy.

### SUMMARY

There may be a plurality of vehicle trains that each perform platooning, and a technique that can more appropriately support platooning of a plurality of vehicle trains is desired.

A travel support device according to the present disclosure supports platooning of a plurality of vehicles. The travel support device includes one or more processors. The one or more processors are configured to: acquire travel preference information indicating a preference of an occupant regarding vehicle traveling, from each of the plurality of vehicles; based on the travel preference information, execute vehicle train formation support processing of supporting formation of a support target vehicle train in which vehicles having similar preferences perform the platooning; and, when there is a plurality of support target vehicle trains, execute first travel control processing of acquiring at least one of the travel preference information and vehicle train travel information from each of the plurality of support target vehicle trains and controlling the platooning of each of the plurality of support target vehicle trains based on the acquired at least one of the travel preference information and the vehicle train travel information.

A travel support method according to the present disclosure supports platooning of a plurality of vehicles. The travel support method, which is executed by a computer, includes: acquiring travel preference information indicating a preference of an occupant regarding vehicle traveling, from each of the plurality of vehicles; based on the travel preference information, executing vehicle train formation support processing of supporting formation of a support target vehicle train in which vehicles having similar preferences perform the platooning; and when there is a plurality of support target vehicle trains, executing first travel control processing of acquiring at least one of the travel preference information and vehicle train travel information from each of the plurality of support target vehicle trains and controlling the platooning of each of the plurality of support target vehicle trains based on the acquired at least one of the travel preference information and the vehicle train travel information.

A non-transitory computer-readable recording medium according to the present disclosure stores a travel support program executed by a computer for supporting platooning of a plurality of vehicles. The travel support program causes the computer to execute: acquiring travel preference information indicating a preference of an occupant regarding vehicle traveling, from each of the plurality of vehicles; based on the travel preference information, executing vehicle train formation support processing of supporting formation of a support target vehicle train in which vehicles having similar preferences perform the platooning; and when there is a plurality of support target vehicle trains, executing first travel control processing of acquiring at least one of the travel preference information and vehicle train travel information from each of the plurality of support target vehicle trains and controlling the platooning of each of the plurality of support target vehicle trains based on the acquired at least one of the travel preference information and the vehicle train travel information.

According to the present disclosure, formation of a vehicle train (a support target vehicle train) in which preferences of occupants of vehicles joining the vehicle train are appropriately satisfied can be supported. Also, according to the present disclosure, the platooning of each of a plurality of support target vehicle trains is controlled in consideration of at least one of travel preference information and vehicle train travel information. Therefore, the platooning of the plurality of support target vehicle trains can be more appropriately supported. In particular, when the travel preference information is considered, the platooning of each of the plurality of support target vehicle trains is controlled based on the travel preference information, and thus the platooning can thus be performed while appropriately satisfying the travel preference wholly in the plurality of support target vehicle trains.

### BRIEF DESCRIPTION OF THE DRAWINGS

FIG. 1 is a conceptual diagram used to describe an overview of a travel support system according to an embodiment;

FIG. 2 is a block diagram showing an example of a configuration of a vehicle and a management server according to an embodiment;

FIG. 3 is a flowchart showing an example of a flow of preference information acquisition processing and vehicle train formation support processing according to an embodiment;

FIG. 4 is a flowchart showing an example of the flow of the vehicle train formation support processing in step S3;

FIG. 5 is a supplementary diagram regarding a degree of match Dm2 of destination preference information;

FIG. 6 is a flowchart used to describe an overview of vehicle train information provision processing according to an embodiment;

FIG. 7 is a diagram used to describe an issue in an example where a plurality of support target vehicle trains T are present;

FIG. 8 is a flowchart used to describe an overview of first travel control processing according to an embodiment;

FIG. 9 is a flowchart showing a first example of the first travel control processing in step S32;

FIG. 10 is a flowchart showing a second example of the first travel control processing in step S32;

FIG. 11 is a flowchart showing a third example of the first travel control processing in step S32;

FIG. 12 is a flowchart showing a fourth example of the first travel control processing in step S32;

FIG. 13 is a flowchart showing a fifth example of the first travel control processing in step S32;

FIG. 14 is a flowchart showing a sixth example of the first travel control processing in step S32;

FIG. 15 is a diagram (comparative example) used to describe an issue during traveling of a support target vehicle train T;

FIG. 16 is a flowchart used to describe second to fourth travel control processing according to an embodiment;

FIG. 17 is a diagram used to describe a first example of the second travel control processing according to an embodiment;

FIG. 18 is a diagram used to describe a second example of the second travel control processing according to an embodiment;

FIG. 19 is a diagram used to describe a third example of the second travel control processing according to an embodiment;

FIG. 20 is a diagram used to describe an example of the third travel control processing according to an embodiment;

FIG. 21 is a diagram used to describe an example of the fourth travel control processing according to an embodiment;

FIG. 22 is a flowchart used to describe vehicle train dissipation processing according to an embodiment;

FIG. 23 is a diagram used to describe another issue during traveling of a support target vehicle train T and vehicle train reconstitution processing as a countermeasure against the another issue;

FIG. 24 is a flowchart used to describe the vehicle train reconstitution processing according to an embodiment;

FIG. 25 is a flowchart used to describe first incentive provision processing according to an embodiment; and

FIG. 26 is a flowchart used to describe second incentive provision processing according to an embodiment.

### DETAILED DESCRIPTION

Embodiments of the present disclosure will be described with reference to the accompanying drawings.

### 1. Overview of Travel Support System

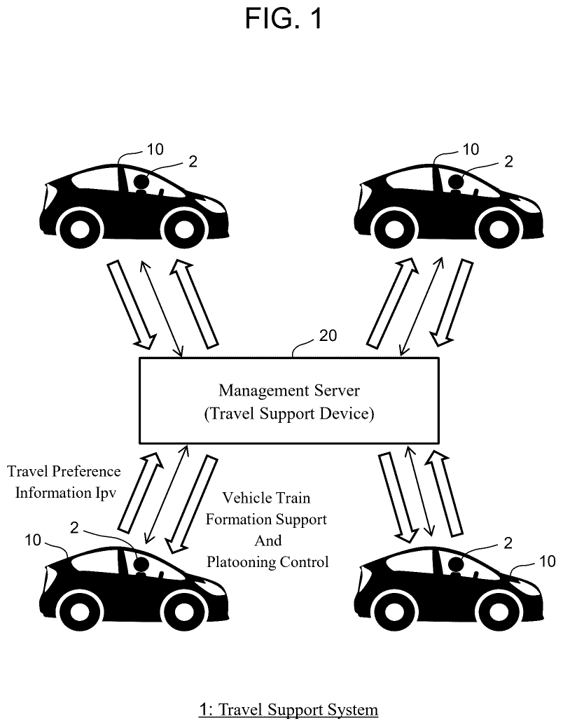

FIG. 1 is a conceptual diagram used to describe an overview of a travel support system 1 according to the present embodiment. The travel support system 1 is a system that supports platooning of a plurality of vehicles 10 (10_1 to 10_N: N is an integer greater than or equal to 2). The travel support system 1 includes the plurality of vehicles 10 and a management server (i.e., central server) 20. The plurality of vehicles 10 are targets of the platooning support by the travel support system 1. For example, the platooning is performed on an exclusive road for automobiles, such as an expressway.

The management server 20 can communicate with each of the plurality of vehicles 10. The management server 20 supports formation of a vehicle train (i.e., a vehicle queue or a convoy) for platooning by vehicles 10 having similar preferences (travel preferences) of occupants 2 regarding vehicle traveling. That is, the “vehicle train” mentioned here refers to a train of vehicles that perform platooning on a road. Hereinafter, a vehicle train that is a support target of vehicle train formation by a plurality of vehicles 10 having similar travel preferences is referred to as a “support target vehicle train T (or simply a vehicle train T)”. Also, the management server 20 controls the traveling of the formed vehicle train T (i.e., the platooning). For example, the management server 20 controls acceleration, deceleration, and lane change of the formed vehicle train T. In addition, the management server 20 corresponds to an example of the “travel support device” according to the present disclosure.

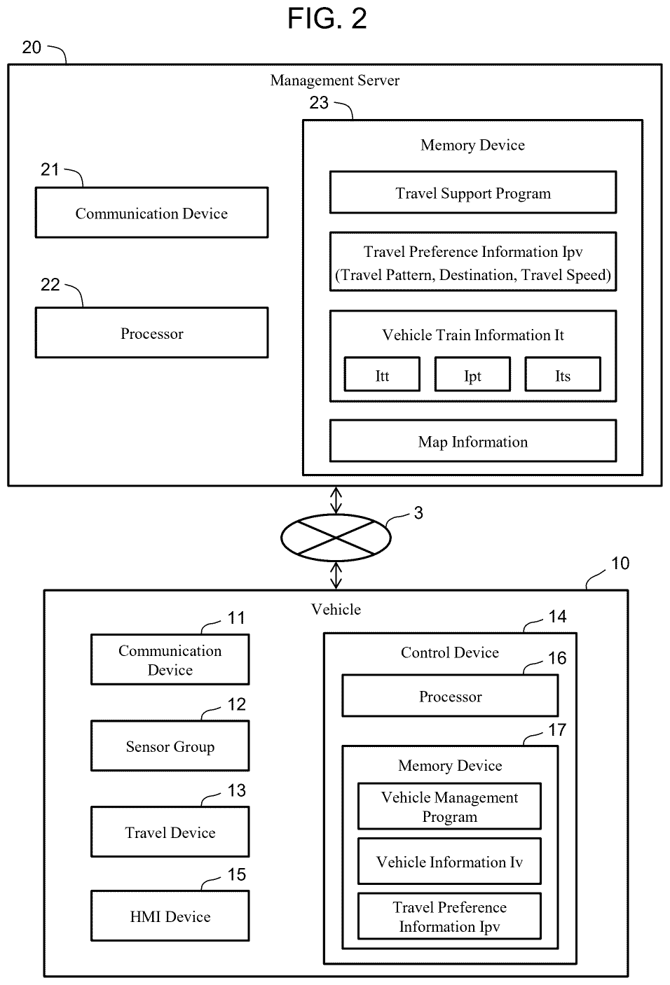

The vehicle 10 may be a manually driven vehicle in which the occupant 2 drives the vehicle 10 as a driver. In the example of the manually driven vehicle, the management server 20 transmits an instruction regarding the platooning (for example, an instruction of travel speed, acceleration, deceleration, or lane change of the vehicle train T) to, for example, an HMI device 15 (see FIG. 2) of each of the vehicles 10 constituting the vehicle train T. As a result, the driver 2 of each vehicle 10 drives the subject vehicle 10 in accordance with the instruction. Further, the instruction may be transmitted only to the lead vehicle 10 of the vehicle train T, for example. As a result, the driver 2 of the lead vehicle 10 drives the lead vehicle 10 in accordance with the instruction, and the driver 2 of each of one or more following vehicles 10 drives the subject vehicle 10 so as to follow the preceding vehicle 10 (including the lead vehicle 10) of the subject vehicle 10. In addition, the “manually driven vehicle” referred to herein may include, for example, a “driving assistance vehicle” having an automated driving function (i.e., driving assistance function) that enables partial automatic travel control (i.e., advanced driving assistance) of level 2 or lower in the automatic driving level defined by the Society of Automotive Engineers (SAE) in the United States. Also, in the example of the driving assistance vehicle, the driver 2 may use driving assistance control (for example, adaptive cruise control (ACC), lane following assistance control) when causing the subject vehicle 10 to follow the preceding vehicle 10.

Moreover, the vehicle 10 may be an automated driving vehicle that can perform automatic traveling. More specifically, the “automated driving vehicle” described herein has an automated driving function of level 3 or higher in the automated driving level described above. In the example of the automated driving vehicle, the management server 20 remotely controls the platooning of the individual vehicles 10 constituting the vehicle train T, for example. More specifically, the management server 20 transmits an instruction related to the platooning to a control device 14 (see FIG. 2) of each vehicle 10, for example. As a result, the control device 14 of each vehicle 10 controls a travel device 13 (see FIG. 2) in accordance with the instruction. Alternatively, the management server 20 may remotely control the travel device 13 of each vehicle 10 directly. Furthermore, the remote control of the platooning of the vehicles 10 by the management server 20 may be performed, for example, only for the lead vehicle 10 in the vehicle train T. In this example, the control device 14 of each of one or more following vehicles 10 controls the automated driving of the subject vehicle 10 so as to follow the preceding vehicle 10 (including the lead vehicle 10) of the subject vehicle 10.

FIG. 2 is a block diagram showing an example of the configuration of the vehicle 10 and the management server 20 according to the present embodiment.

As shown in FIG. 2, the vehicle 10 includes a communication device 11, sensor group 12, the travel device 13, the control device 14, and the human machine interface (HMI) device 15.

The communication device 11 communicates with the outside of the vehicle 10. The communication device 11 performs wireless communication with the management server 20 via a communication network 3, for example. The communication device 11 may include a vehicle-to-vehicle communication device that enables communication between the subject vehicle 10 and a surrounding vehicle 10 (i.e., vehicle-to-vehicle communication (V2V)).

The sensor group 12 includes a recognition sensor, a vehicle state sensor, and a position sensor, for example. The recognition sensor recognizes (detects) a situation around the vehicle 10. Examples of the recognition sensor include a camera, a laser imaging detection and ranging (LIDAR), and a radar. The vehicle state sensor detects the state of the vehicle 10. Examples of the vehicle state sensor include a speed sensor, an acceleration sensor, a yaw rate sensor, and a steering angle sensor. The position sensor detects a position and an orientation of the vehicle 10. For example, the position sensor includes a global navigation satellite system (GNSS) receiver.

The travel device 13 is a device that operates the vehicle 10. The travel device 13 includes a drive device, a brake device, and a steering device. The drive device includes, for example, at least one of an electric motor and an internal combustion engine for driving (accelerating) the vehicle 10. The brake device includes a brake actuator for braking (decelerating) the vehicle 10. The steering device includes an electric motor for turning the wheels of the vehicle 10.

The control device 14 controls the vehicle 10. The control device 14 includes one or more processors 16 (hereinafter, simply referred to as a processor 16) and one or more memory devices 17 (hereinafter, simply referred to as a memory device 17). The processor 16 executes various kinds of processing. Examples of the processor 16 include a general-purpose processor, a special-purpose processor, a central processing unit (CPU), a graphics processing unit (GPU), an application specific integrated circuit (ASIC), and a field-programmable gate array (FPGA). The processor 16 may also be referred to as processing circuitry. The memory device 17 stores various kinds of information. Examples of the memory device 17 include a volatile memory, a nonvolatile memory, a hard disk drive (HDD), and a solid state drive (SSD). The processor 16 executes a vehicle management program (computer program) including a vehicle control program. The vehicle management program is stored in the memory device 17. Alternatively, the vehicle management program may be recorded in a non-transitory computer-readable recording medium or may be provided via the communication network 3. The function of the control device 14 may be realized by cooperation between the processor 16 that executes the vehicle management program and the memory device 17.

The various kinds of information stored in the memory device 17 includes vehicle information Iv and travel preference information Ipv. The vehicle information Iv is information on the vehicle 10, and includes, for example, vehicle state information, surrounding situation information, position information, vehicle type information, and travel distance information. The vehicle state information is information indicating the state of the vehicle 10, such as the vehicle speed (travel speed), the acceleration, and the yaw rate, and is acquired using, for example, the sensor group 12 (vehicle state sensor). The surrounding situation information is information indicating the surrounding situation of the vehicle 10, and is acquired using, for example, the sensor group 12 (recognition sensor). The surrounding situation information may include object information regarding objects (for example, other vehicles, white lines, traffic lights, signs, roadside structures) around the vehicle 10. The position information is information indicating the position and the orientation of the vehicle 10, and is acquired using, for example, the sensor group 12 (position sensor). The vehicle type information is information indicating the type of the vehicle 10 (for example, passenger car, truck, or bus). The travel preference information Ipv will be described below.

The HMI device 15 is an interface between the vehicle 10 and the occupant 2 and is mounted on the vehicle 10, for example. Specifically, the HMI device 15 includes an output unit that outputs information to the occupant 2 and an input unit (for example, a touch panel, an operation button, an operation switch, a microphone) to which information is input by the occupant 2. The output unit includes, for example, a display device and a speaker. The display device is, for example, a display (for example, a meter panel) mounted on an instrument panel of the vehicle 10 or a head-up display (HUD) that displays information on a windshield of the vehicle 10. The HMI device 15 notifies the occupant 2 of various kinds of information based on an instruction from the control device 14. Also, the HMI device 15 transmits information input by the occupant 2 to the control device 14. The HMI device 15 may have a navigation function of guiding the traveling of the vehicle 10. In addition, a mobile device (for example, a smartphone or a tablet terminal) of the occupant 2 may be communicably connected to the control device 14 in a wired or wireless manner, for example, and may function as the HMI device 15.

As illustrated in FIG. 2, the management server 20 includes a communication device 21, one or more processors 22 (hereinafter, simply referred to as a processor 22), and one or more memory devices 23 (hereinafter, simply referred to as a memory device 23). The communication device 21 performs wireless communication with the vehicle 10 via the communication network 3.

The processor 22 executes various kinds of processing for supporting the platooning of the plurality of vehicles 10. Examples of the processor 22 include a CPU, a GPU, an ASIC, and an FPGA. The processor 22 may also be referred to as processing circuitry. The memory device 23 stores various kinds of information. Examples of the memory device 23 include a volatile memory, a nonvolatile memory, an HDD, and an SSD. The processor 22 executes a travel support program (computer program). The travel support program is stored in the memory device 23. Alternatively, the travel support program may be recorded in a non-transitory computer-readable recording medium or may be provided via the communication network 3. The function of the management server 20 may be realized by cooperation between the processor 22 that executes the travel support program and the memory device 23.

The various kinds of information stored in the memory device 23 includes the travel preference information Ipv, vehicle train information It, and map information. The travel preference information Ipv is acquired from each vehicle 10. The vehicle train information It includes, for each vehicle train T, a vehicle train identification (ID), vehicle train travel information Itt, travel preference information Ipt, and vehicle train surrounding situation information Its, for example. The vehicle train travel information Itt is information indicating the traveling state of the vehicle train T, and includes, for example, the position, the travel speed, and the number of lane changes (the number N2 of lane changes described below) of the vehicle train T. The vehicle train travel information Itt can be acquired based on the vehicle information Iv from each vehicle 10, for example. The travel preference information Ipt is information indicating the travel preference of the vehicle train T, and can be specified by, for example, a method described in step S11 described below. The vehicle train surrounding situation information Its is information indicating the surrounding situation of the vehicle train T, and includes, for example, information of surrounding vehicles (including emergency vehicles) of the vehicle train T and road traffic information (for example, traffic density, traffic volume, congestion, traffic regulation, and traffic accidents). The vehicle train surrounding situation information Its can be acquired based on, for example, the vehicle information Iv (surrounding situation information) from each vehicle 10 or information from an external system (for example, a road traffic information providing system). The map information includes information (for example, road shape and lane information) of a road on which the vehicle train T travels.

### 2. Processing Related to Platooning Support

There may be a plurality of vehicle trains T that each perform platooning, and a technique that can more appropriately support the platooning of a plurality of vehicle trains T is desired. More specifically, the preference (travel preference) regarding vehicle traveling may differ depending on the occupant 2. Also, when viewed from the entire vehicle train T that performs the platooning, the travel preference may also differ depending on the vehicle train T. Therefore, it is desirable that, when a plurality of vehicle trains T are present, the control of the platooning is executed while appropriately satisfying the travel preference wholly in the plurality of vehicle trains T.

Accordingly, in the present embodiment, the management server 20 (processor 22) executes “preference information acquisition processing”, “vehicle train formation support processing”, and “first travel control processing” as follows for the purpose of the platooning support.

### 2-1. Preference Information Acquisition Processing and Vehicle Train Formation Support Processing

In the preference information acquisition processing, the management server 20 acquires the “travel preference information Ipv” from each of the plurality of vehicles 10 that are targets of the platooning support. Then, in the vehicle train formation support processing, the management server 20 supports the formation of the vehicle train T in which the vehicles 10 having similar travel preferences perform the platooning, based on the acquired travel preference information Ipv.

The travel preference information Ipv is information indicating the preference of the occupant 2 (e.g., the driver) regarding the traveling of the vehicle 10. In detail, in one example, the travel preference information Ipv includes travel pattern preference information Ipv1 on a desired travel pattern, destination preference information Ipv2 on a desired destination, and travel speed preference information Ipv3 on a desired travel speed. The travel pattern can also be referred to as a travel mode. In another example, the travel preference information Ipv may include only one or two of the travel pattern preference information Ipv1, the destination preference information Ipv2, and the travel speed preference information Ipv3.

### Desired Travel Pattern

The desired travel pattern may include, for example, any two or more of a “travel efficiency priority pattern”, a “safety priority pattern”, a “fuel efficiency priority pattern”, and an “on-time observance priority pattern” as candidates for selection by the occupant 2. The travel efficiency priority pattern is a pattern that focuses on traveling to reach a destination earlier (for example, aggressively performing overtaking). The safety priority pattern is a pattern that focuses on traveling to arrive at a destination more safely (for example, allowing an arrival delay of less than a designated time). The fuel efficiency priority pattern is a pattern that focuses on low fuel-efficient traveling. The on-time observance priority pattern is a pattern that focuses on traveling on time (for example, arriving at each location at a designated point of time as in a route bus).

Moreover, the desired travel pattern may be specified by at least one of the preference of a “lane change frequency” and the preference of a “speed range”, for example. The lane change frequency mentioned here is the number of lane changes per designated time, and the speed range is the magnitude of the allowable speed difference with respect to a target speed set when the vehicle 10 is traveling.

The travel pattern preference information Ipv1 may be acquired in advance in each of the vehicles 10 by the following method. That is, for example, the control device 14 of each vehicle 10 may request the occupant 2 to select (input) a desired travel pattern through the HMI device 15. More specifically, for example, the control device 14 may request the occupant 2 to select a desired travel pattern from designated candidates (for example, the travel efficiency priority pattern and the safety priority pattern). Alternatively, the control device 14 may request the occupant 2 to input a numerical value that matches the preference of the occupant 2 from among numerical values of the lane change frequency determined in advance, for example. This is the same for the speed range.

Furthermore, the control device 14 stores the desired travel pattern selected (input) by the occupant 2 as described above in the memory device 17 as the travel pattern preference information Ipv1. Alternatively, the control device 14 may specify the desired travel pattern based on the travel record of the vehicle 10 driven by the occupant 2 in the past and store the specified desired travel pattern in the memory device 17 as the travel pattern preference information Ipv1. In addition, machine learning may be used to specify the desired travel pattern in this manner.

Additionally, it can be said that the desired travel pattern described above indicates the priority of the occupant 2 for the traveling (driving) of the vehicle 10.

### Desired Destination

The destination preference information Ipv2 may be acquired in advance in each of the vehicles 10 by the following method. That is, for example, the control device 14 may request the occupant 2 to select (input) a desired destination through the HMI device 15. When the desired destination is input to the HMI device 15, the control device 14 stores the input desired destination in the memory device 17 as the destination preference information Ipv2.

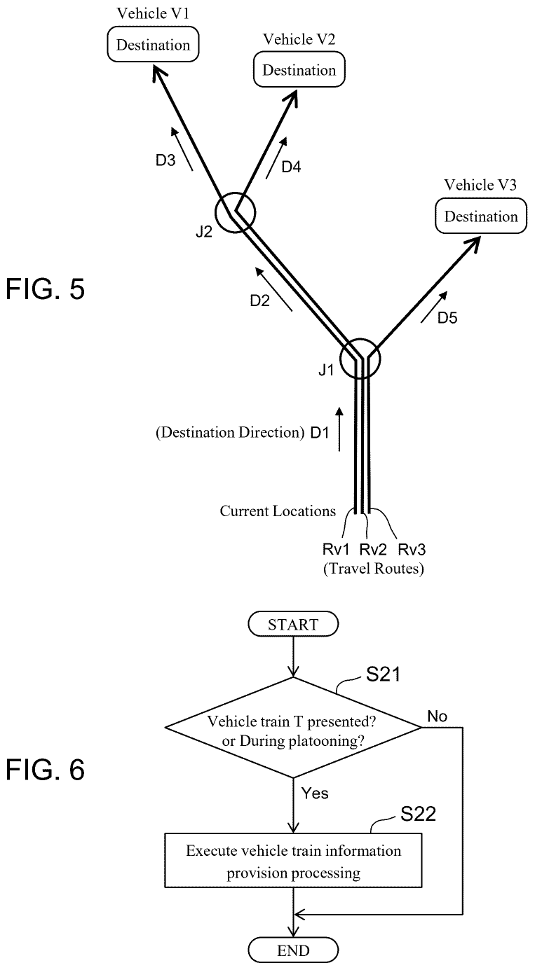

Moreover, the HMI device 15 may include a processor configured to generate a travel route Rv of the vehicle 10 based on the position information on the current location and the destination of the vehicle 10 and the map information. Also, the information on the desired destination as the destination preference information Ipv2 may be a “destination direction (for example, see FIG. 5 described below)” specified by the travel route Rv to the destination.

### Desired Travel Speed

The travel speed preference information Ipv3 in each of the vehicles 10 may be acquired in advance by, for example, the following method. That is, the control device 14 may request the occupant 2 to select (input) a desired travel speed through the HMI device 15. More specifically, the control device 14 may request the occupant 2 to input a numerical value of the desired travel speed (for example, 80 km/h, 100 km/h). Alternatively, the control device 14 may request the occupant 2 to select a desired travel speed as a rough speed range (for example, low speed, medium speed, high speed) instead of a specific numerical value (i.e., a set speed) of the desired travel speed. Then, the control device 14 may store the desired travel speed input (selected) by the occupant 2 in the memory device 17 as the travel speed preference information Ipv3. Alternatively, for example, the control device 14 may specify the desired travel speed based on the travel record of the vehicle 10 during the past driving by the occupant 2 and store the specified desired travel speed in the memory device 17 as the travel speed preference information Ipv3.

### Others

The travel preference information Ipv may include information indicating a preference of the occupant 2 regarding other elements other than the desired travel pattern, the desired destination, and the desired travel speed. The other elements may be, for example, characteristics of the vehicles 10 constituting the vehicle train T. More specifically, the travel preference information Ipv may include, for example, information indicating a preference for platooning in which only vehicles 10 of the same type (e.g., trucks or passenger cars) are included, and a preference for platooning in which vehicles 10 of different types are allowed to be mixed. Furthermore, the other elements may be, for example, vehicle-to-vehicle information (more specifically, vehicle-to-vehicle time or vehicle-to-vehicle distance) with the preceding and following vehicles 10 during the platooning, and thus the travel preference information Ipv may include information indicating a preference regarding the length of the vehicle-to-vehicle time or the vehicle-to-vehicle distance.

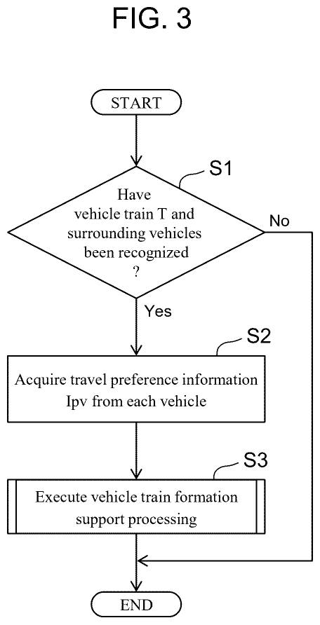

FIG. 3 is a flowchart showing an example of the flow of the preference information acquisition processing and the vehicle train formation support processing according to the present embodiment. The processing of this flowchart is executed to support the vehicle 10 having a travel preference close to that of the support target vehicle train T to join the vehicle train T. When there is a plurality of vehicle trains T, the management server 20 executes the processing of this flowchart for each vehicle train T.

Additionally, the “support target vehicle train T” subject to the processing in FIG. 3 is an expression indicating not only a vehicle train (that is, the collection of a plurality of vehicles 10) itself formed after two or more vehicles 10 are first gathered, but also one vehicle 10 served as the center when the two or more vehicles 10 are first gathered for vehicle train formation. The one vehicle 10 serving as the center may be specified as follows, for example. That is, the management server 20 may specify a vehicle having the standard travel preference information Ipv among the two or more vehicles 10 as the one vehicle 10 serving as the center.

In FIG. 3, in step S1, the management server 20 (processor 22) determines whether or not the vehicle train T and one or more surrounding vehicles 10 of the vehicle train T have been recognized. Specifically, the management server 20 specifies the vehicle train T that is the target of the processing this time based on the vehicle train information It. Then, the management server 20 executes processing of recognizing one or more of surrounding vehicles 10 with respect to the vehicle train T on the basis of, for example, the position information of the specified vehicle train T and the position information of the surrounding vehicles 10 that do not currently form a vehicle train. In addition, the one or more surrounding vehicles 10 may include not only one or more vehicles 10 that are traveling but also one or more vehicles 10 that are stopped at a place, such as a service area.

When one or more surrounding vehicles 10 with respect to the vehicle train T are not recognized (step S1; No), the processing proceeds to “END”. On the other hand, when one or more surrounding vehicles 10 are recognized (step S1; Yes), the processing proceeds to step S2. The processing of steps S2 and S3 may be executed when the management server 20 receives requests from one or more surrounding vehicles 10 requesting to join the vehicle train T, instead of the processing of step S1.

In step S2, the management server 20 acquires the travel preference information Ipv from each of the vehicles 10 constituting the vehicle train T and each of the recognized one or more surrounding vehicles 10 (preference information acquisition processing). The acquired travel preference information Ipv is stored in the memory device 23. Thereafter, the processing proceeds to step S3.

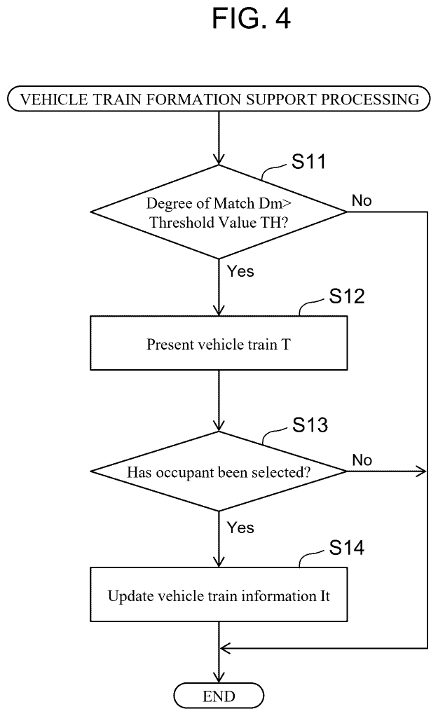

In step S3, the management server 20 executes the vehicle train formation support processing. FIG. 4 is a flowchart showing an example of the flow of the vehicle train formation support processing in step S3. When a plurality of surrounding vehicles 10 are recognized, the processing shown in FIG. 4 is executed for each of the surrounding vehicles 10.

In FIG. 4, in step S11, the management server 20 determines whether or not the degree of match Dm between the travel preference information Ipt of the vehicle train T and the travel preference information Ipv of the surrounding vehicle 10 is higher than a designated threshold value TH. In addition, in step S11, when two or more vehicles 10 are first gathered to form the vehicle train T, the degree of match Dm of the travel preference information Ipv between one vehicle 10 serving as the center of the vehicle train formation and the surrounding vehicle 10 is compared with the threshold value TH.

The degree of match Dm may be quantified in the form of a score SC, for example. For example, the score SC may be calculated to be 0 when the travel preference information Ipt and the travel preference information Ipv completely match each other, and to be greater when the difference between the travel preference information Ipt and the travel preference information Ipv is greater. That is, the degree of match Dm increases when the score SC approaches 0. Therefore, the management server 20 determines that the degree of match Dm is higher than the threshold value TH when the score SC is lower than a designated threshold value.

To be more specific, in an example in which the travel preference information Ipv includes the travel pattern preference information Ipv1, the destination preference information Ipv2, and the travel speed preference information Ipv3, the management server 20 may calculate scores SC1, SC2, and SC3 corresponding to the respective degrees of match Dm1, Dm2, and Dm3, and calculate the sum of the calculated scores SC1, SC2, and SC3 as the score SC. Further, as shown in Equation 1 described below, the scores SC1, SC2, and SC3 may be multiplied by the respective coefficients K (e.g., K1, K2, and K3). Then, the coefficients K may be determined such that the value of one coefficient K corresponding to the preference information of which the degree of reflection on the score SC is desired to be increased is greater than the value of at least one of other coefficients K. For example, in order to increase the degree of reflection of the travel pattern preference information Ipv1 on the score SC, the coefficient K1 may be determined to be greater than at least one of the other coefficients K2 and K3.

$$SC = SC 1 \times K 1 + SC 2 \times K 2 + SC 3 \times K 3 \qquad ( 1 )$$

FIG. 5 is a supplementary diagram regarding the degree of match Dm2 of the destination preference information. FIG. 5 illustrates an example of travel routes Rv1, Rv2, and Rv3 of three vehicles 10 (referred to as vehicles V1, V2, and V3). In FIGS. 5, J1 and J2 are junctions at which the vehicle travel directions diverge. In the example illustrated in FIG. 5, the travel route Rv1 includes destination directions D1, D2, and D3, the travel route Rv2 includes destination directions D1, D2, and D4, and the travel route Rv3 includes destination directions D1 and D5. In this example, when viewed from the vehicle V1, it can be said that the preference of “destination direction” (destination preference information Ipv2) of the vehicle V2 having a large number of common destination directions (in other words, having a long platooning available section) is closer to that of the vehicle V1 than that of the vehicle V3. Therefore, in an example in which the information of the destination direction is used as the destination preference information Ipv2, the degree of match Dm2 may be determined as follows, for example. That is, when, for example, the destination preference information Ipt2 of the vehicle train T is equal to the destination preference information Ipv2 of the vehicle V1 in FIG. 5, the degree of match Dm2 between the destination preference information Ipt2 and the destination preference information Ipv2 of the vehicle V2 may be determined to be higher than the degree of match Dm2 between the destination preference information Ipt2 and the destination preference information Ipv2 of the vehicle V3.

The travel preference information Ipt (Ipt1 to Ipt3) of the vehicle train T used in step S11 can be determined as follows based on the travel preference information Ipv (Ipv1 to Ipv3) of the individual vehicles 10 constituting the vehicle train T. That is, for example, a statistical value (for example, a mean value, a variance, or a deviation (an average deviation or a standard deviation)) calculated from the quantified travel preference information Ipv of each of the vehicles 10 constituting the vehicle train T may be used as the travel preference information Ipt of the vehicle train T.

Additionally, the travel pattern preference information Ipt1 of the vehicle train T may be determined as follows. That is, as can be seen from the processing shown in FIG. 4, it can be said that the individual vehicles 10 constituting the vehicle train T have the travel pattern preference information Ipv1 with a high degree of match Dm1. Therefore, when the desired travel pattern is common to all the constituent vehicles 10, the management server 20 may determine the common desired travel pattern (for example, the travel efficiency priority pattern) as the travel pattern preference information Ipt1 (that is, the desired travel pattern of the vehicle train T). Further, even when the desired travel pattern is not common to all the constituent vehicles 10, the management server 20 may determine, as the travel pattern preference information Ipt 1, a desired travel pattern that is common to the largest number of constituent vehicles 10 among all the constituent vehicles 10. This is the same for the other destination preference information Ipt2 and the travel speed preference information Ipt3 of the vehicle train T.

In FIG. 4, when the degree of match Dm is equal to or lower than the threshold value TH (step S11; No), the processing proceeds to “END”. That is, the management server 20 excludes the surrounding vehicle 10 that is a target of the determination in step S11 this time from consideration for joining the vehicle train T. In addition, when the management server 20 does not find any of the surrounding vehicles 10 having the degree of match Dm higher than the threshold value TH, the management server 20 may perform the processing illustrated in FIG. 4 again for one or more surrounding vehicles 10 recognized in the processing of step SI while lowering the threshold value TH.

On the other hand, when the degree of match Dm is higher than the threshold value TH (step S11; Yes), the processing proceeds to step S12. In step S12, the management server 20 presents, to the surrounding vehicle 10 that is a target of the determination in step S11 this time, the vehicle train T as a candidate of vehicle train that the surrounding vehicle 10 joins. The presentation of the vehicle train Tis performed for the occupant 2 of the surrounding vehicle 10 through the HMI device 15. The presentation of the vehicle train T is performed, for example, with information necessary for the occupant 2 to determine whether to participate in the vehicle train T. Examples of the information include information on the degree of match Dm of the travel preference information between the vehicle train T and the subject vehicle 10, and information on the time needed for the subject vehicle 10 to reach the vehicle train T.

In step S13 subsequent to step S12, the management server 20 determines whether or not the management server 20 has received intention expression information indicating that the occupant 2 selected to join the vehicle train T from the surrounding vehicle 10 that received the presentation of the vehicle train T.

When the intention expression information is not received within a designated time from the presentation of the vehicle train T (step S13; No), the process proceeds to “END”. On the other hand, when the intention expression information is received (step S13; Yes), the processing proceeds to step S14. In step S14, the management server 20 updates the vehicle train information It such that information of the surrounding vehicle 10 that has transmitted the intention expression information is added.

According to the vehicle train formation support processing described above, it is possible to support the formation of the vehicle train T in which the travel preference of the occupant 2 of each vehicle 10 participating in the vehicle train T is appropriately satisfied. Thus, the occupant 2 of each vehicle 10 can obtain a benefit by participating in the vehicle train T while reducing the degree of sacrificing the travel preference of the occupant 2. In addition, according to the travel preference information Ipv used in the present embodiment, it is possible to support the formation of the vehicle train T while appropriately considering the travel preference of the occupant 2 of each vehicle 10 on the basis of at least one of the desired travel pattern, the desired destination, and the desired travel speed.

Moreover, the processing of step S1 (see FIG. 3) may be executed to recognize a plurality of vehicle trains T. Then, in the vehicle train formation support processing, the management server 20 may specify a plurality of candidates of the vehicle train T to be presented to the occupant 2 of the surrounding vehicle 10 and present the plurality of specified candidates to the occupant 2. Thus, the occupant 2 can select a vehicle train T to be joined from among a plurality of candidates. Therefore, the occupant 2 can more actively select a vehicle train T that more suitably satisfies his/her expectation.

### Merging Support Processing

Furthermore, the vehicle train formation support processing may include a “merging support processing” that, after an occupant 2 selects to join a vehicle train T, supports the vehicle 10 of the occupant 2 to travel to join the vehicle train T. Specifically, in an example in which the vehicle 10 is a manually driven vehicle (including the driving assistance vehicle described above), the merging support processing may include, for example, notifying the occupant 2 of at least one of a notification of a travel route until the vehicle 10 joins the vehicle train T, an instruction of lane change, and an instruction of a travel speed, through the HMI device 15. Further, in an example in which the vehicle 10 is the automated driving vehicle described above, the merging support processing may include, for example, that the management server 20 remotely controls the traveling of the vehicle 10 until the vehicle 10 joins the vehicle train T. According to the merging support processing, even when the vehicle 10 selected to join the vehicle train Tis, for example, far from the vehicle train T, the management server 20 that knows the position information of the vehicle 10 and the vehicle train T can smoothly guide the vehicle 10 to the vehicle train T.

### 2-1-1. Vehicle Train Information Provision Processing

Even if information necessary for determining whether to participate in the vehicle train T is provided to a vehicle 10 when the vehicle train T is presented to the vehicle 10 (see step S12), it may be difficult for the occupant 2 of the vehicle 10 to determine whether or not the vehicle train T really matches the travel preference of the subject vehicle 10. In other words, if the occupant 2 of the vehicle 10 cannot know in advance how the platooning will be performed (e.g., travel speed, arrival time at the destination, and lane change frequency) when the vehicle 10 joins the vehicle train T, the travel preference of the occupant 2 may not match the platooning of the vehicle train T after the vehicle 10 actually joins the vehicle train T.

Moreover, when the vehicles 10 are already traveling in a row in the vehicle train T, the way of traveling in a row in the vehicle train T may change, for example, in response to participation of a new vehicle 10 in the vehicle train T or a change in the traveling environment of the vehicle train T. In other words, the traveling state of the vehicle train T may change with the passage of time from the initial formation of the vehicle train T and may not match the travel preference of the occupant 2 of the vehicle 10. Furthermore, the occupant 2 whose travel preference no longer matches that of the vehicle train T may desire to leave the vehicle train T. However, if the occupant 2 cannot accurately know the current traveling state of the vehicle train T, it is difficult for the occupant 2 to appropriately grasp whether or not the traveling state of the vehicle train T matches the travel preference of the occupant 2.

Accordingly, the management server 20 may execute the following “vehicle train information provision processing”. FIG. 6 is a flowchart used to describe an overview of the vehicle train information provision processing according to the present embodiment.

In step S21, the management server 20 determines whether or not the time to present a vehicle train T to a vehicle 10 has come (see step S12) and whether or not vehicles 10 are traveling in a row in the vehicle train T. As a result, when the time to present a vehicle train T has not come or vehicles 10 are not traveling in a row (step S21; No), the processing proceeds to “END”. On the other hand, when the time has come or vehicles 10 are traveling in a row (step S21; Yes), the processing proceeds to step S22.

In step S22, the management server 20 executes the vehicle train information provision processing. To be specific, the management server 20 provides the vehicle train information It regarding the vehicle train T to the vehicle 10 that is a target of the determination in the processing of step S21, through the HMI device 15 of the vehicle 10.

The provided vehicle train information It may include, for example, the current vehicle train travel information Itt. Examples of the current vehicle train travel information Itt include the number N1 of vehicles 10 forming (i.e., constituting) the vehicle train T, the travel speed, the lane change frequency, the travel preference information Ipt for the vehicle train T, and the statistical value of the travel preference information Ipv of the vehicles 10 constituting the vehicle train T. An example of the statistical value is a variance or a mean value of the values of the respective kinds of travel preference information Ipv1 to Ipv3. More specifically, the travel preference information Ipt mentioned here is a value used for the actual platooning of the vehicle train T. Examples of the value include a desired travel speed used as a target speed of the vehicle train T, and a desired destination used as a destination of the vehicle train T.

Furthermore, the provided vehicle train information It may include information on the operation of the vehicle train T. Examples of the information include: an estimated arrival time of the vehicle train T at the destination of the vehicle train T; at least one of a platooning available section on a travel route to the destination of the vehicle 10 that is a target of the provision of the information and a final point of the section; an estimated passage time at a point on the travel route; and at least one of a time and a distance from the formation of the vehicle train T.

According to the vehicle train information provision processing described above, it is possible to provide information useful for the occupant 2 to more comfortably use the platooning, with the vehicle 10 that is about to join the vehicle train T or the vehicle 10 that is already traveling in a row in the vehicle train T.

### 2-2. First Travel Control Processing

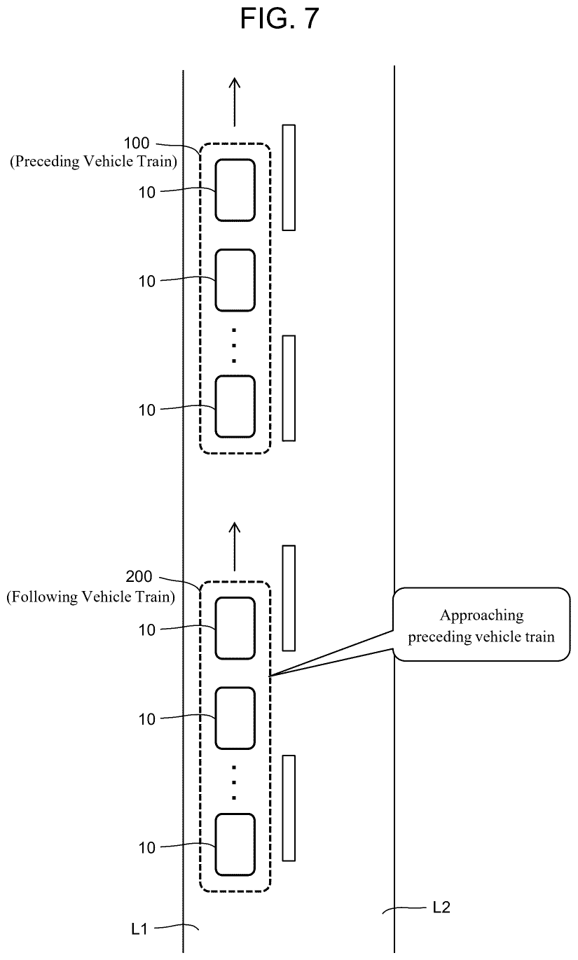

FIG. 7 is a diagram used to describe an issue in an example where a plurality of support target vehicle trains T are present. When a plurality of vehicle trains travel at close distances from each other, one vehicle train may impede the traveling of another vehicle train. FIG. 7 illustrates a preceding vehicle train 100 and a following vehicle train 200 which are two support target vehicle trains T traveling in the same travel lane L1.

For example, when the travel speed of the following vehicle train 200 is higher than the travel speed of the preceding vehicle train 100, the preceding vehicle train 100 having a low travel speed may impede the traveling (i.e., the platooning) of the following vehicle train 200 that has caught up with the preceding vehicle train 100. To be more specific, the following vehicle train 200 is impeded by the preceding vehicle train 100, which is slow, and may not travel at a desirable speed according to the travel preference information Ipt (more specifically, the travel speed preference information Ipt3) of the following vehicle train 200. On the other hand, when the traveling of the preceding vehicle train 100 is carelessly controlled so as not to impede the traveling of the following vehicle train 200, the traveling (platooning) of the preceding vehicle train 100 may not match the travel preference information Ipt of the preceding vehicle train 100.

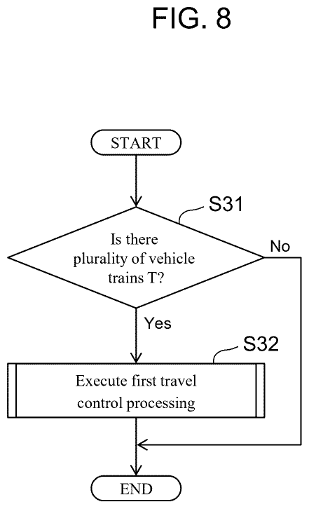

Accordingly, in the present embodiment, the management server 20 executes the “first travel control processing” as follows. FIG. 8 is a flowchart used to describe an overview of the first travel control processing according to the present embodiment.

In step S31, the management server 20 determines whether or not there is a plurality of vehicle trains T. Specifically, for example, the management server 20 executes processing of recognizing a plurality of vehicle trains T traveling within a designated distance range based on the vehicle train travel information Itt (position information). As a result, when there is no plurality of vehicle trains T (step S31; No), the processing proceeds to “END”. On the other hand, when there is a plurality of vehicle trains T as in the example of the preceding vehicle train 100 and the following vehicle train 200 shown in FIG. 7 (step S31; Yes), the processing proceeds to step S32.

In step S32, the management server 20 executes the first travel control processing. That is, the management server 20 acquires at least one of the travel preference information Ipt and the vehicle train travel information Itt from each of the plurality of recognized vehicle trains T. How to acquire one or both of the travel preference information Ipt and the vehicle train travel information Itt varies depending on how to execute the first travel control processing (see first to sixth examples described below).

Then, in step S32, the management server 20 controls the platooning of each of the plurality of vehicle trains T on the basis of at least one of the acquired travel preference information Ipt and the vehicle train travel information Itt. More specifically, the management server 20 transmits, for each of the plurality of vehicle trains T, a control instruction for controlling the platooning to each of the vehicles 10 constituting the vehicle train T.

The control instruction (for example, an instruction to accelerate, decelerate, or change lanes) generated when the occupant 2 (driver) is driving the vehicle 10 (more specifically, when the occupant 2 is performing at least a driving operation of the vehicle 10 corresponding to the control instruction) is transmitted to the occupant 2 via a notification displayed on the HMI device 15 of the vehicle 10. The occupant 2 who has confirmed the notification performs the driving operation of the vehicle 10 in accordance with the notified control instruction. Further, an instruction (a remote-control instruction) for the management server 20 to remotely control the vehicle 10 corresponds to the control instruction generated when the vehicle 10 is in the automated driving. The remote-control instruction is transmitted to, for example, the control device 14 of the vehicle 10. As a result, the control device 14 that has received the control instruction controls the travel device 13 in accordance with the control instruction. Alternatively, the remote-control instruction may be transmitted to the travel device 13 via the control device 14 or not via the control device 14 and may directly control the travel device 13. Furthermore, in order for the occupant 2 to easily grasp the situation of the platooning, the HMI device 15 of the vehicle 10 which is an automated driving vehicle may notify the occupant 2 of the content (for example, acceleration, deceleration, or lane change) of the automatic travel control of the vehicle 10 performed in response to the remote-control instruction from the management server 20.

### First Example

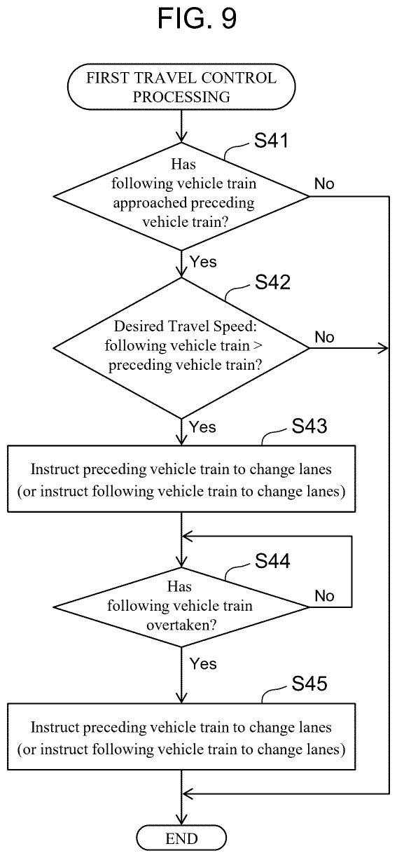

FIG. 9 is a flowchart showing the first example of the first travel control processing in step S32.

In step S41, the management server 20 determines whether or not the following vehicle train 200 has approached the preceding vehicle train 100. Specifically, the management server 20 determines whether or not the distance of the lead vehicle 10 of the following vehicle train 200 from the last vehicle 10 of the preceding vehicle train 100 is less than a designated threshold value based on, for example, the vehicle train travel information Itt (position information). As a result, when the following vehicle train 200 is not approaching (step S41; No), the processing proceeds to “END”. On the other hand, when the following vehicle train 200 has approached (step S41; Yes), the processing proceeds to step S42.

In step S42, the management server 20 determines whether or not the desired travel speed of the following vehicle train 200 is higher than the desired travel speed of the preceding vehicle train 100 on the basis of the travel preference information Ipt (travel speed preference information Ipt3). As a result, when the desired travel speed of the following vehicle train 200 is not higher than that of the preceding vehicle train 100 (step S42; No), the processing proceeds to “END”. On the other hand, when the following vehicle train 200 has a higher desired travel speed (step S42; Yes), the processing proceeds to step S43.

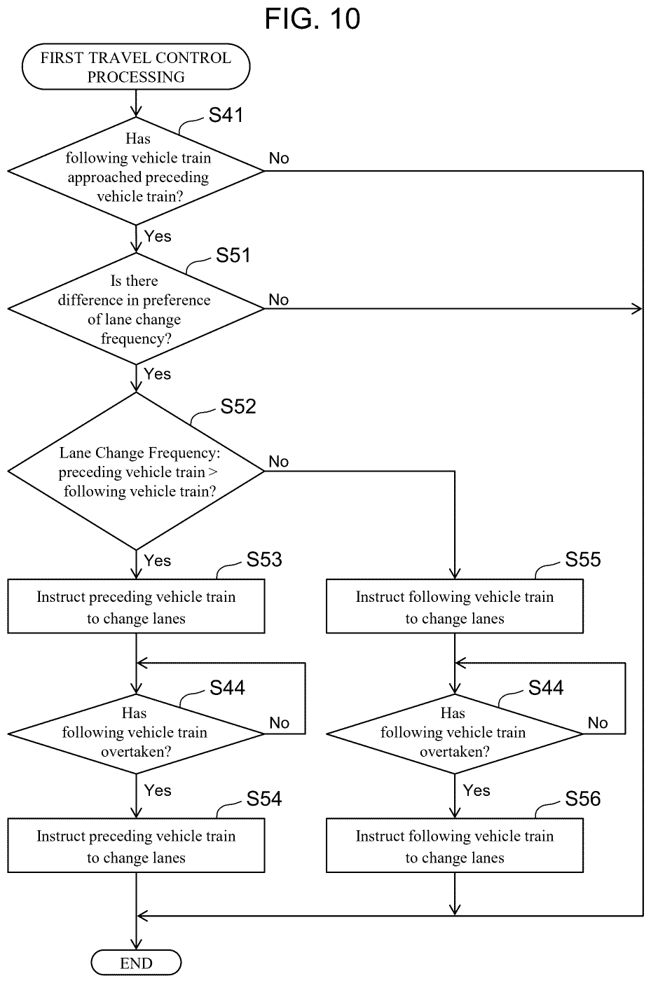

In step S43, the management server 20 instructs each of the vehicles 10 constituting the preceding vehicle train 100 to make a lane change (for example, a lane change from L1 to L2 in FIG. 7) for causing the following vehicle train 200 to move ahead of the preceding vehicle train 100. Alternatively, the management server 20 may instruct each of the vehicles 10 constituting the following vehicle train 200 to make a lane change (for example, a lane change from L1 to L2 in FIG. 7). In addition, the processing of step S43 may include an instruction to accelerate or decelerate at least one of the preceding vehicle train 100 and the following vehicle train 200 in order to more smoothly make the lane change. This also applies to steps S53 and S55 (see FIG. 10) described below.

In step S44 subsequent to step S43, the management server 20 determines whether or not the following vehicle train 200 has overtaken the preceding vehicle train 100 based on, for example, the vehicle train travel information Itt (position information). As a result, when the overtaking is completed (step S44; Yes), the processing proceeds to step S45.

In step S45, the management server 20 instructs each of the vehicles 10 constituting the preceding vehicle train 100 to make a lane change to return to the original travel lane L1 (for example, a lane change from L2 to L1 in FIG. 7). Alternatively, the management server 20 may instruct each of the vehicles 10 constituting the following vehicle train 200 to make a lane change (for example, a lane change from L2 to L1 in FIG. 7).

According to the first example described above, when the plurality of vehicle trains T (the preceding vehicle train 100 and the following vehicle train 200) approach each other, the platooning of both of the vehicle trains T can be appropriately maintained while preventing the platooning of each of the plurality of vehicle trains T from not matching one's travel preference (desired travel speed).

### Second Example

FIG. 10 is a flowchart showing the second example of the first travel control processing in step S32. The processing of this flowchart is different from the flowchart shown in FIG. 9 in the following points.

In FIG. 10, when the following vehicle train 200 has approached the preceding vehicle train 100 (step S41; Yes), the processing proceeds to step S51. In step S51, the management server 20 determines whether or not the preference of the lane change frequency of the preceding vehicle train 100 is different from the preference of the lane change frequency of the following vehicle train 200 based on the travel preference information Ipt (travel pattern preference information Ipt1). As a result, when the preference of the lane change frequency of the preceding vehicle train 100 is not different from that of the following vehicle train 200 (step S51; No), the processing proceeds to “END”. On the other hand, when the preference of the lane change frequency of the preceding vehicle train 100 is different from that of the following vehicle train 200 (step S51; Yes), the processing proceeds to step S52.

In step S52, the management server 20 determines whether or not the lane change frequency preferred by the preceding vehicle train 100 is higher than that of the following vehicle train 200 based on the travel preference information Ipt. As a result, when the preceding vehicle train 100 prefers (allows) a higher lane change frequency (step S52; Yes), the processing proceeds to step S53. On the other hand, when the following vehicle train 200 prefers (allows) a higher lane change frequency (step S52; No), the processing proceeds to step S55.

In step S53, the management server 20 instructs each of the vehicles 10 constituting the preceding vehicle train 100 to make a lane change (for example, a lane change from L1 to L2 in FIG. 7) for causing the following vehicle train 200 to move ahead of the preceding vehicle train 100. Then, after the following vehicle train 200 overtakes the preceding vehicle train 100 (step S44: Yes), the management server 20 instructs each of the vehicles 10 constituting the preceding vehicle train 100 to make a lane change (for example, a lane change from L2 to L1 in FIG. 7) to return to the original travel lane (step S54).

On the other hand, in step S55, the management server 20 instructs each of the vehicles 10 constituting the following vehicle train 200 to make a lane change (for example, a lane change from L1 to L2 in FIG. 7) for causing the following vehicle train 200 to move ahead of the preceding vehicle train 100. Then, after the following vehicle train 200 overtakes the preceding vehicle train 100 (step S44: Yes), the management server 20 instructs each of the vehicles 10 constituting the following vehicle train 200 to make a lane change (for example, a lane change from L2 to L1 in FIG. 7) to return to the original travel lane (step S56).

Even according to the second example described above, when the plurality of vehicle trains T approach each other, the platooning of both of the vehicle trains T can be appropriately maintained while preventing the platooning of each of the plurality of vehicle trains T from not matching one's travel preference (preference of the lane change frequency).

### Third Example

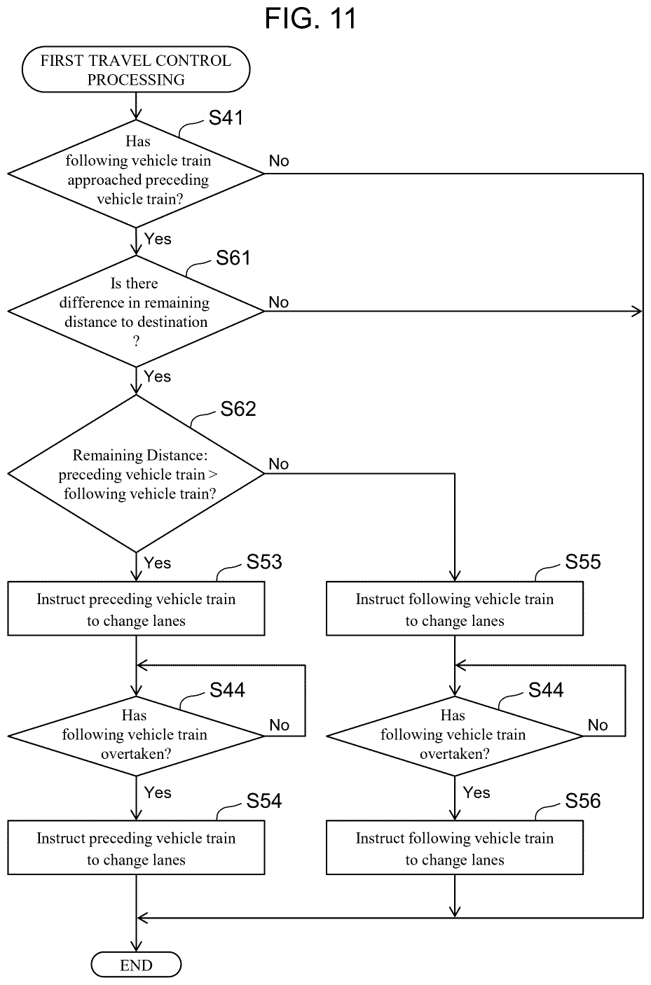

FIG. 11 is a flowchart showing the third example of the first travel control processing in step S32. The processing of this flowchart is different from the flowchart shown in FIG. 10 in the following points. The destination preference information Ipt2 for the vehicle train T may include information on a remaining distances Dr to a desired destination (that is, the end point of the platooning) of the vehicle train T.

In FIG. 11, when the following vehicle train 200 has approached the preceding vehicle train 100 (step S41; Yes), the processing proceeds to step S61. In step S61, the management server 20 determines whether or not the remaining distance Dr to the destination is different between the preceding vehicle train 100 and the following vehicle train 200. The remaining distance Dr can be acquired based on, for example, the destination preference information Ipt2 (information on the desired destination) and the vehicle train travel information Itt (position information). As a result, when the preceding vehicle train 100 is not different from the following vehicle train 200 in the remaining distance Dr (step S61; No), the processing proceeds to “END”. On the other hand, when the preceding vehicle train 100 is different from the following vehicle train 200 in the remaining distance Dr (step S61; Yes), the processing proceeds to step S62.

In step S62, the management server 20 determines whether or not the remaining distance Dr of the preceding vehicle train 100 is longer than that of the following vehicle train 200. As a result, when the preceding vehicle train 100 has a longer remaining distance Dr (step S62; Yes), the processing proceeds to step S53. On the other hand, when the following vehicle train 200 has a longer remaining distance Dr (step S62; No), the processing proceeds to step S55.

For example, when a vehicle train A (i.e., the preceding vehicle train 100 or the following vehicle train 200) having a shorter remaining distance Dr approaches the end point of the platooning, if the vehicle train A makes the lane change described above, the occupant 2 of a vehicle 10 included in the vehicle train A may feel uneasy or uncomfortable about the execution of the lane change (that is, may feel that the lane change does not match the travel preference of the occupant 2). Conversely, even if the vehicle train B having a margin to the end point of the platooning makes the lane change under the above-described situation, the occupant 2 of vehicle 10 included in the vehicle train B is unlikely to feel uneasy or uncomfortable. Therefore, even according to the third example described above, when a plurality of vehicle trains T approach each other, the platooning of both of the vehicle trains T can be appropriately maintained while preventing the platooning of each of the plurality of vehicle trains T from not matching one's travel preference.

### Fourth Example

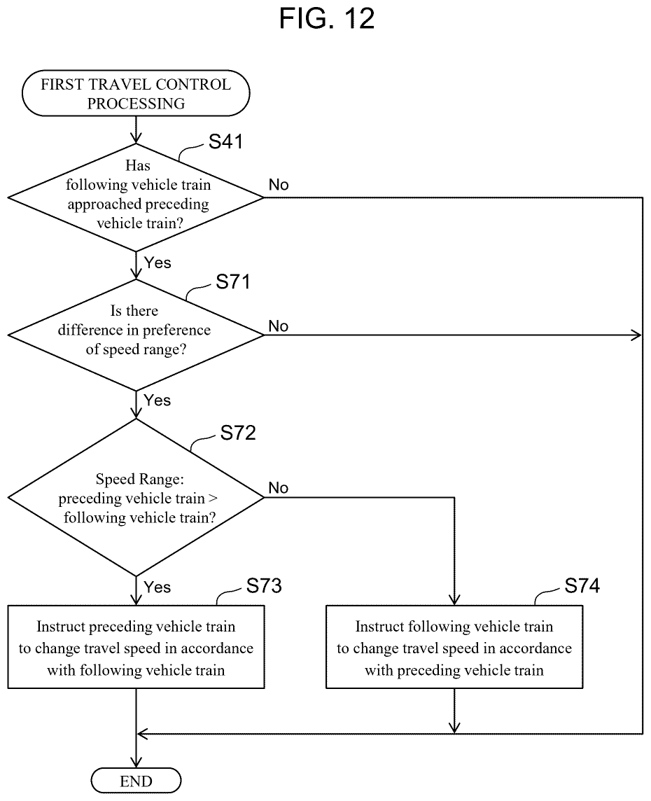

FIG. 12 is a flowchart showing the fourth example of the first travel control processing in step S32. The processing of this flowchart is different from the flowchart shown in FIG. 10 in the following points.

In FIG. 12, when the following vehicle train 200 has approached the preceding vehicle train 100 (step S41; Yes), the processing proceeds to step S71. In step S71, the management server 20 determines whether or not the preference of the speed range is different between the preceding vehicle train 100 and the following vehicle train 200 based on the travel preference information Ipt (the travel pattern preference information Ipt1). As a result, when the preference of the speed range of the preceding vehicle train 100 is not different from that of the following vehicle train 200 (step S71; No), the processing proceeds to “END”. On the other hand, when the preference of the speed range of the preceding vehicle train 100 is different from that of the following vehicle train 200 (step S71; Yes), the processing proceeds to step S72.

In step S72, the management server 20 determines whether or not the speed range preferred by the preceding vehicle train 100 is wider than that of the following vehicle train 200. As a result, when the preceding vehicle train 100 prefers a wider speed range (step S72; Yes), the processing proceeds to step S73. On the other hand, when the following vehicle train 200 prefers a wider speed range (step S72; No), the processing proceeds to step S74.

In step S73, the management server 20 instructs each of the vehicles 10 constituting the preceding vehicle train 100, which prefers a wider speed range than the following vehicle train 200, to change the travel speed in accordance with the travel speed of the following vehicle train 200 (i.e., another vehicle train). Specifically, for example, the management server 20 acquires the travel speed of the following vehicle train 200 from the following vehicle train 200. Then, when the vehicles 10 that are targets of the instruction are manually driven vehicles (including the driving assistance vehicles described above), the management server 20 uses the notification to the HMI device 15 to request the occupant 2 of each vehicle 10 of the preceding vehicle train 100 to change the travel speed in accordance with the acquired travel speed of the following vehicle train 200. In addition, when the vehicles 10 that are targets of the instruction are automated driving vehicles, the management server 20 remotely controls each vehicle 10 of the preceding vehicle train 100 so as to change the travel speed in accordance with the acquired travel speed of the following vehicle train 200.

On the other hand, in step S74, the management server 20 instructs each of the vehicles 10 constituting the following vehicle train 200, which prefers a wider speed range than the preceding vehicle train 100, to change the travel speed in accordance with the travel speed of the preceding vehicle train 100. The instruction can be performed in the same manner as that of step S73 while replacing the instruction target from the preceding vehicle train 100 to the following vehicle train 200.

Even according to the fourth example described above, when a plurality of vehicle trains T approach each other, the platooning of both of the vehicle trains T can be appropriately maintained while preventing the platooning of each of the plurality of vehicle trains T from not matching one's travel preference (preference of the speed range).

### Fifth Example

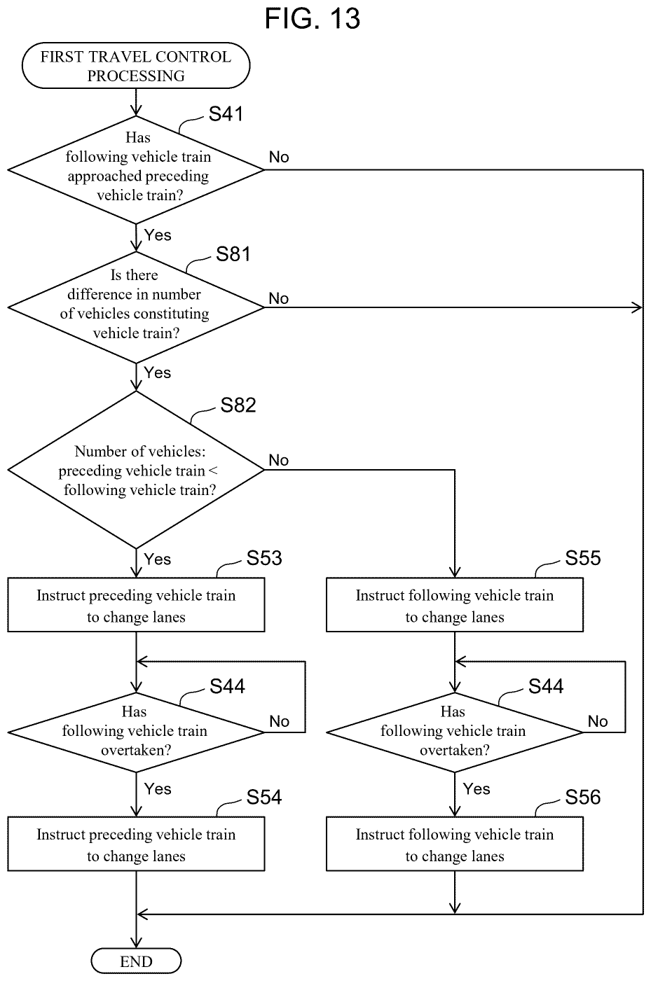

FIG. 13 is a flowchart showing the fifth example of the first travel control processing in step S32. The processing of this flowchart is different from the flowchart shown in FIG. 10 in the following points.

In the fifth example, the control instruction to the vehicle train T is performed based on the vehicle train travel information Itt instead of the travel preference information Ipt. To be specific, the vehicle train travel information Itt may include information on the number N1 of vehicles 10 constituting the vehicle train T. The information on the number N1 of vehicles 10 is updated by the management server 20 so as to increase with the number of vehicle 10 joining the vehicle train T and decrease with the number of vehicles 10 leaving the vehicle train T.

In FIG. 13, when the following vehicle train 200 has approached the preceding vehicle train 100 (step S41; Yes), the processing proceeds to step S81. In step S81, the management server 20 determines whether or not the number N1 of vehicles 10 is different between the preceding vehicle train 100 and the following vehicle train 200 based on the vehicle train travel information Itt. As a result, when the number N1 of vehicles 10 of the preceding vehicle train 100 is not different from that of the following vehicle train 200 (step S81; No), the processing proceeds to “END”. On the other hand, when the number N1 of vehicles 10 of the preceding vehicle train 100 is different from that of the following vehicle train 200 (step S81; Yes), the processing proceeds to step S82.

In step S82, the management server 20 determines whether or not the number N1 of vehicles 10 constituting the preceding vehicle train 100 is smaller than the number N1 of vehicles 10 constituting the following vehicle train 200. As a result, when the preceding vehicle train 100 has a smaller number N1 of vehicles 10 (step S82; Yes), the processing proceeds to step S53. That is, the management server 20 causes the preceding vehicle train 100, which is easy to change lanes as the vehicle train T because the number N1 of vehicles 10 is smaller, to change lanes (step S53). On the other hand, when the following vehicle train 200 has a smaller number N1 of vehicles 10 (step S82; No), the processing proceeds to step S55. That is, the management server 20 causes the following vehicle train 200, which is easy to change lanes as the vehicle train T because the number N1 of vehicles 10 is smaller, to change lanes (step S55).

According to the fifth example described above, when a plurality of vehicle trains T approach each other, the platooning of each of the plurality of vehicle trains T is controlled in consideration of the vehicle train travel information Itt (the number N1 of vehicles 10 constituting the vehicle train T), and the platooning of the plurality of vehicle trains T can thus be more appropriately supported.

### Sixth Example

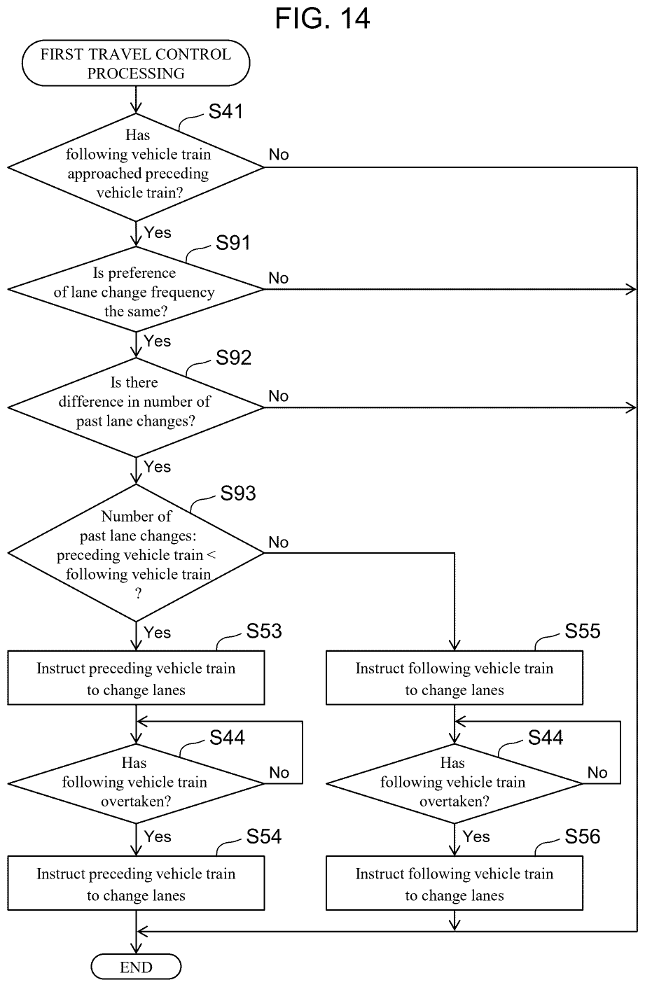

FIG. 14 is a flowchart showing the sixth example of the first travel control processing in step S32. The processing of this flowchart is different from the flowchart shown in FIG. 10 in the following points. In the sixth example, the control instruction to the vehicle train T is performed based on both the travel preference information Ipt and the vehicle train travel information Itt.

In FIG. 14, when the following vehicle train 200 has approached the preceding vehicle train 100 (step S41; Yes), the processing proceeds to step S91. In step S91, the management server 20 determines whether or not the preference of the lane change frequency is the same between the preceding vehicle train 100 and the following vehicle train 200 based on the travel preference information Ipt. The term “same” used herein does not necessarily mean “completely same” and may include a scope in which the two are regarded as substantially same. When the preceding vehicle train 100 is not the same as the following vehicle train 200 in the preference of the lane change frequency (step S91; No), the processing proceeds to “END”. On the other hand, when the preference of the lane change frequency of the preceding vehicle train 100 is the same as that of the following vehicle train 200 (step S91; Yes), the processing proceeds to step S92.

In step S92, the management server 20 determines whether or not the number N2 of past lane changes as the vehicle train T is different between the preceding vehicle train 100 and the following vehicle train 200 based on the vehicle train travel information Itt. As a result, when the preceding vehicle train 100 is not different from the following vehicle train 200 in the number N2 of lane changes (step S92; No), the processing proceeds to “END”. On the other hand, when the preceding vehicle train 100 is different from the following vehicle train 200 in the number of lane changes N2 (step S92; Yes), the processing proceeds to step S93.

In step S93, the management server 20 determines whether or not the number N2 of past lane changes of the preceding vehicle train 100 is smaller than the number N2 of past lane changes of the following vehicle train 200. As a result, when the preceding vehicle train 100 has a smaller number N2 of lane changes (step S93; Yes), the processing proceeds to step S53. On the other hand, when the following vehicle train 200 has a smaller number N2 of lane changes (step S93; No), the processing proceeds to step S55.

According to the sixth example described above, when a plurality of vehicle trains T approach each other, the platooning of both of the vehicle trains T can be appropriately maintained while preventing the platooning of each of the plurality of vehicle trains T from not matching one's travel preference (preference of the lane change frequency) also in consideration of the vehicle train travel information Itt (the number N2 of past lane changes).

According to the first travel control processing described above, the platooning of each of the plurality of vehicle train T is controlled in consideration of at least one of the travel preference information Ipt and the vehicle train travel information Itt. Thus, it is possible to more appropriately support the platooning of the plurality of vehicle trains T. In particular, when the travel preference information Ipt is considered, the platooning of each of the plurality of vehicle trains T is controlled based on the travel preference information Ipt, and the platooning can thus be performed while appropriately satisfying the travel preference wholly in the plurality of vehicle trains T.

### 3. Further Processing Related to Platooning Support

For the platooning support, the management server 20 may additionally execute at least one of “any one of second travel control processing, third travel control processing, and fourth travel control processing”, “vehicle train dissipation processing”, “vehicle train reconstitution processing”, “first incentive provision processing”, and “second incentive provision processing” described below.

### 3-1. Second to Fourth Travel Control Processing

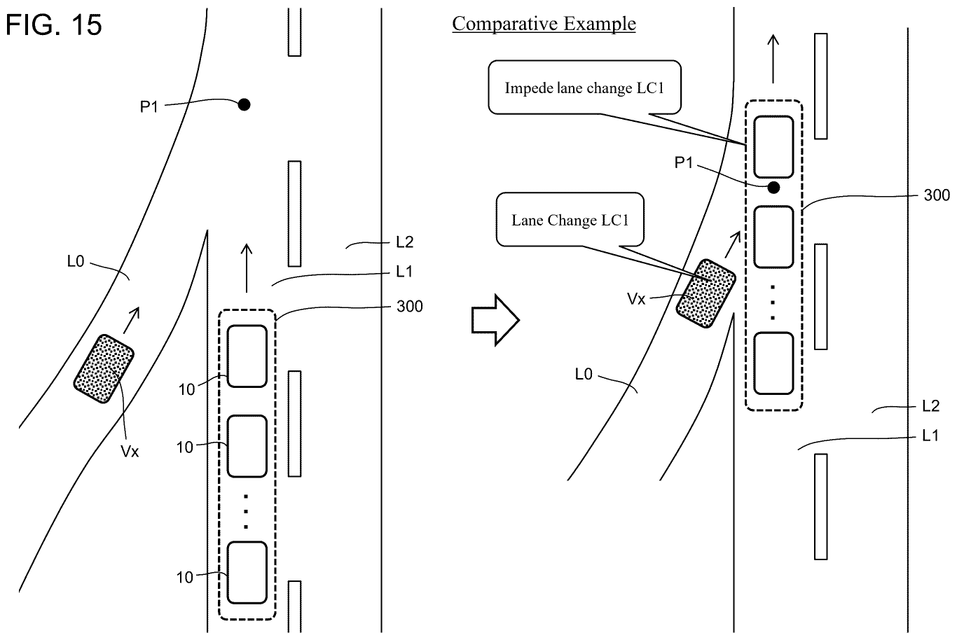

FIG. 15 is a diagram (comparative example) used to describe an issue during traveling of the support target vehicle train T. When another vehicle is traveling in a travel lane adjacent to a travel lane of a vehicle train, the presence of the vehicle train may impede smooth traveling of the another vehicle. In one example, FIG. 15 illustrates a situation in which another vehicle Vx traveling in a merging lane L0 change lanes to a travel lane L1 of a vehicle train 300 (i.e., the support target vehicle train T). Hereinafter, for convenience of description, a lane change to the travel lane L1 of the vehicle train 300 by the vehicle Vx is referred to as a “lane change LC1”.

As shown in FIG. 15, when the vehicle train 300 passes through a merging point P1 at the timing at which the vehicle Vx arrives at the merging point P1, the lane change LC1 (merging) of the vehicle Vx is impeded by the vehicle train 300. Further, when the vehicle Vx forcibly makes the lane change LC1 and cuts into the middle of the vehicle train 300, the vehicle train 300 cannot be maintained. Furthermore, this issue may occur not only in the lane change LC1 as the merging into a travel lane of the main roadway (for example, FIG. 15), but also in another lane change LC1 due to a decrease in the number of travel lanes in the main roadway, and in still another lane change LC1 between adjacent travel lanes in the main roadway.

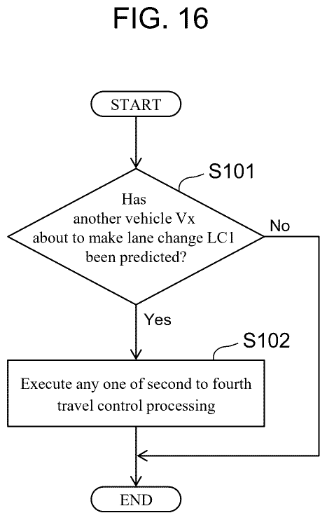

Accordingly, the management server 20 may execute the “second travel control processing”, the “third travel control processing”, or the “fourth travel control processing” as follows. FIG. 16 is a flowchart used to describe the second to fourth travel control processing according to the present embodiment.

In step S101, the management server 20 determines whether or not another vehicle Vx (for example, see FIG. 15) that is about to make a lane change LC1 has been predicted. A way of predicting another vehicle Vx is not particularly limited. That is, for example, when the management server 20 recognizes, by using the sensor group 12 (recognition sensor) of a vehicle 10 included in the vehicle train 300, that the vehicle Vx traveling in a travel lane (for example, the merging lane L0) adjacent to the travel lane L1 of the vehicle train 300 has approached the travel lane L1, the management server 20 may predict the vehicle Vx that is about to make the lane change LC1. Alternatively, the management server 20 may predict the vehicle Vx that will make the lane change LC1, for example, when recognizing that the vehicle train 300 has approached a point or section (e.g., a merging point or a lane reduction point) where the lane change LC1 of the vehicle Vx is predicted geographically, based on the map information and the vehicle train travel information Itt (position information).

When the vehicle Vx that is about to make the lane change LC1 is not predicted (step S101; No), the processing proceeds to “END”. On the other hand, when the vehicle Vx is predicted (step S101; Yes), the processing proceeds to step S102. In step S102, the management server 20 executes any one of the second to fourth travel control processing for instructing the vehicle train 300 to travel so as not to impede the lane change LC1 of the vehicle Vx.

### 3-1-1. Second Travel Control Processing

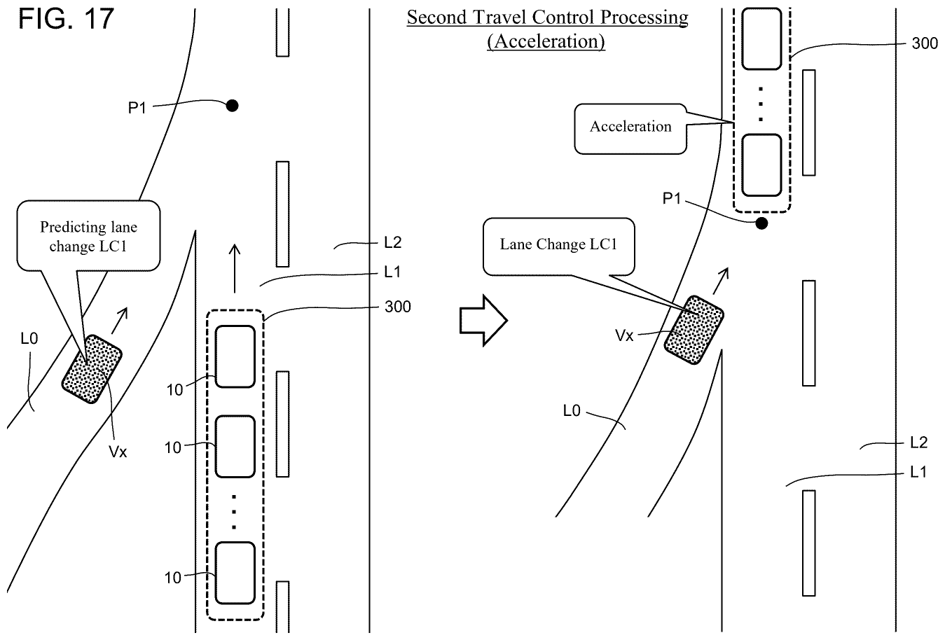

FIG. 17 is a diagram used to describe the first example of the second travel control processing according to the present embodiment. In the first example, when another vehicle Vx that is about to make a lane change LC1 is predicted, the management server 20 instructs each of the vehicles 10 included in the vehicle train 300 to accelerate so as not to impede the lane change LC1 of the vehicle Vx. The acceleration instruction is performed in the same manner as the control instruction in the first travel control processing. That is, the acceleration instruction to each vehicle 10 during the manual driving is transmitted to the occupant 2 via the notification displayed on the HMI device 15. Also, an instruction for the management server 20 to accelerate each vehicle 10 by remote control corresponds to the acceleration instruction to each vehicle 10 during the automated driving. As a result of the acceleration instruction, as shown in FIG. 17, the vehicle train 300 (that is, all the vehicles 10 constituting the vehicle train 300) accelerates on the travel lane L1. As a result, the impedance of the lane change LC1 of the vehicle Vx by the vehicle train 300 is avoided or reduced.

Additionally, the target of the acceleration instruction for the vehicle train 300 is not limited to each vehicle 10 (that is, all vehicles 10) included in the vehicle train 300, and may be only the lead vehicle 10 of the vehicle train 300. This is the same for the second and third examples of the second travel control processing.

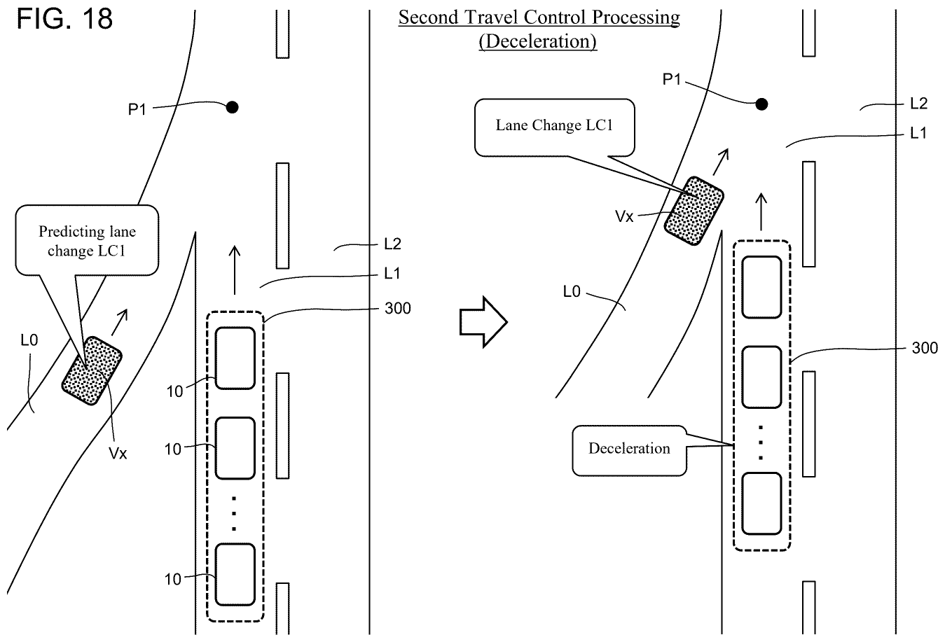

FIG. 18 is a diagram used to describe the second example of the second travel control processing according to the present embodiment. In the second example, when another vehicle Vx that is about to make a lane change LC1 is predicted, the management server 20 instructs each of the vehicles 10 included in the vehicle train 300 to decelerate so as not to impede the lane change LC1 of the vehicle Vx. To be specific, the deceleration instruction to each vehicle 10 during the manual driving is transmitted to the occupant 2 via the notification displayed on the HMI device 15. Also, an instruction for the management server 20 to decelerate each vehicle 10 by remote control corresponds to the deceleration instruction to each vehicle 10 during the automated driving. As a result of the deceleration instruction, as shown in FIG. 18, the vehicle train 300 (that is, all the vehicles 10 constituting the vehicle train 300) decelerates on the travel lane L1. As a result, the impedance of the lane change LC1 of the vehicle Vx by the vehicle train 300 is avoided or reduced.

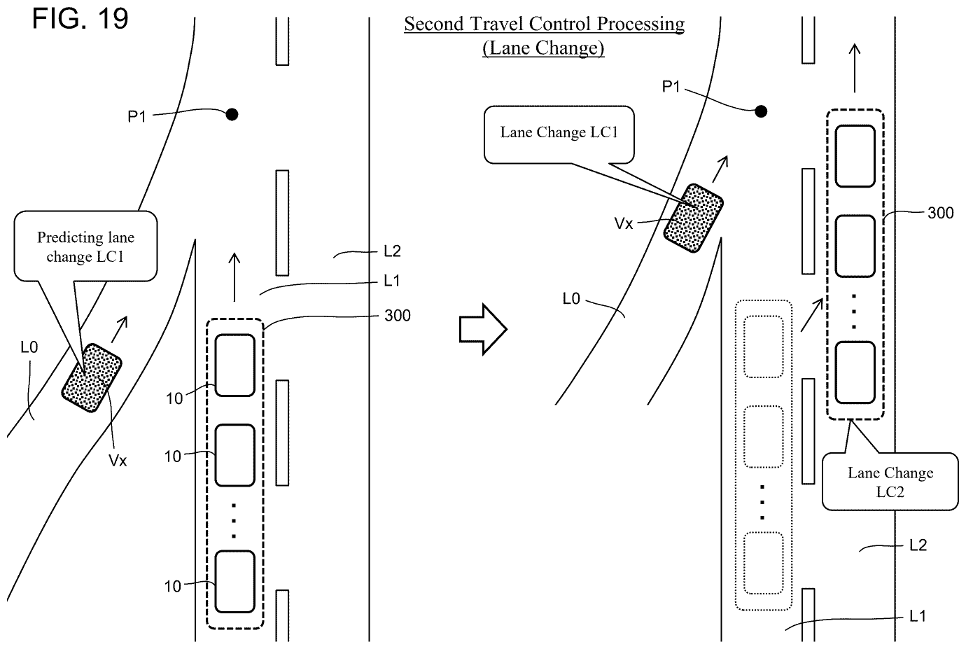

FIG. 19 is a diagram used to describe the third example of the second travel control processing according to the present embodiment. In the third example, when another vehicle Vx that is about to make a lane change LC1 is predicted, the management server 20 instructs each of the vehicles 10 included in the vehicle train 300 to make a “lane change LC2” so as not to impede the lane change LC1 of the vehicle Vx. As shown in FIG. 19, this lane change LC2 is a lane change of the vehicle train 300 to a travel lane L2 adjacent to the travel lane LI of the vehicle train 300 on the opposite side of the travel lane (e.g., the merging lane L0) of the vehicle Vx. To be specific, the instruction of the lane change LC2 to each vehicle 10 during the manual driving is transmitted to the occupant 2 via the notification displayed on the HMI device 15. Also, an instruction for the management server 20 to cause each vehicle 10 to make the lane change LC2 by remote control corresponds to the instruction of the lane change LC2 to each vehicle 10 during the automated driving. As a result of the instruction of the lane change LC2, as shown in FIG. 19, the vehicle train 300 (that is, all the vehicles 10 constituting the vehicle train 300) makes the lane change LC2. As a result, the impedance of the lane change LC1 of the vehicle Vx by the vehicle train 300 is avoided or reduced.

### 3-1-2. Third Travel Control Processing

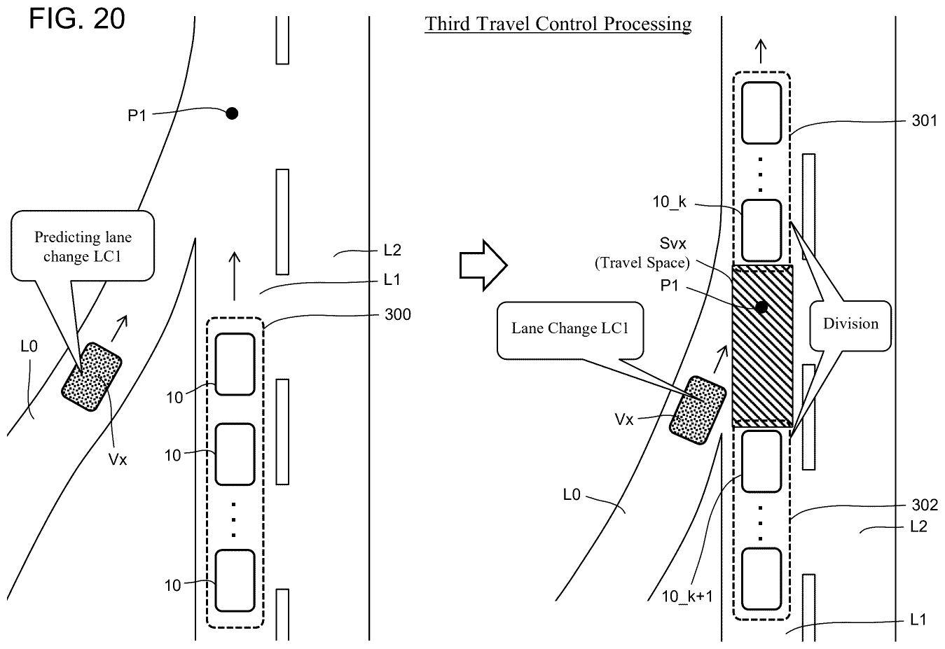

FIG. 20 is a diagram used to describe an example of the third travel control processing according to the present embodiment. In this example, when another vehicle Vx that is about to make a lane change LC1 is predicted, the management server 20 first specifies a vehicle train 301 and a vehicle train 302 acquired by dividing the vehicle train 300 in such a manner as not to impede the lane change LC1 of the vehicle Vx. The vehicle train 301 is constituted by one or more vehicles 10 from the head of the plurality of vehicles 10 constituting the vehicle train 300. The vehicle train 302 is constituted by remaining one or more vehicles 10 among the plurality of vehicles 10. The vehicle train 301 and the vehicle train 302 correspond to examples of the “first vehicle train” and the “second vehicle train” according to the present disclosure, respectively.

The vehicle train 301 and the vehicle train 302 are specified as follows, for example. That is, the management server 20 communicates with, for example, the vehicle Vx and acquires information on the position and the travel speed of the vehicle Vx. Then, the management server 20 calculates (estimates) a time point t1 at which the vehicle Vx arrives at a point P1 (for example, a merging point) where the vehicle Vx overlaps with the vehicle train 300 at the time of the lane change LC1, based on the acquired information on the position and the travel speed of the vehicle Vx and the map information. Also, the management server 20 specifies a vehicle 10x that passes through the point P1 at the time point t1 if the vehicle train 300 continues to travel as it is, based on the vehicle train travel information Itt (e.g., the position and the travel speed), the map information, and the time point t1. Further, for example, the management server 20 specifies the vehicle trains 301 and 302 such that the vehicle train 301 includes the vehicle 10x (i.e., vehicle 10_k in FIG. 20) as the last vehicle in the vehicle train 301. Alternatively, the management server 20 may specify the vehicle trains 301 and 302 such that the vehicle train 302 includes the vehicle 10x (i.e., vehicle 10_k+1 in FIG. 20) as the lead vehicle in the vehicle train 302.

Then, the management server 20 gives an instruction (i.e., a notification to the HMI device 15 or a remote-control instruction) to each of the vehicles 10 included in the vehicle train 300 to form the vehicle trains 301 and 302 while securing a travel space Svx for the vehicle Vx between the vehicle train 301 and the vehicle train 302.

To be more specific, in the example in which the vehicle train 301 includes the vehicle 10x described above, the management server 20 instructs each of the vehicles 10 included in the vehicle train 301 to accelerate in order to secure the travel space Svx. Alternatively, the management server 20 may instruct the each of the vehicles 10 to make a lane change LC2 to the travel lane L2 in order to secure the travel space Svx. Further, the management server 20 may instruct each of the vehicles 10 included in the vehicle train 302 to decelerate in order to secure a more sufficient travel space Svx, together with the above-described instruction to accelerate or make a lane change LC2 to each of the vehicles 10 included in the vehicle train 301. In addition, the target of the instruction of the acceleration or the lane change LC2 to the vehicle train 301 is not limited to each of the vehicles 10 included in the vehicle train 301 and may be only the lead vehicle 10 of the vehicle train 301.

On the other hand, in the example in which the vehicle train 302 includes the vehicle 10x described above, the management server 20 instructs each of the vehicles 10 included in the vehicle train 302 to decelerate in order to secure the travel space Svx.

Alternatively, the management server 20 may instruct the each of the vehicles 10 to make a lane change LC2 to the travel lane L2 in order to secure the travel space Svx. Further, the management server 20 may instruct each of the vehicles 10 included in the vehicle train 301 to accelerate in order to secure a more sufficient travel space Svx, together with the above-described instruction to decelerate or make a lane change LC2 to each of the vehicles 10 included in the vehicle train 302. In addition, the target of the instruction of the deceleration or the lane change LC2 to the vehicle train 302 is not limited to each of the vehicles 10 included in the vehicle train 302 and may be only the lead vehicle 10 of the vehicle train 302.

Additionally, when the vehicle train 300 is divided into the vehicle trains 301 and 302 as described above, the management server 20 updates the vehicle train information It so as to reflect the information on the vehicle trains 301 and 302.

Even according to the third travel control processing described above, the impedance of the lane change LC1 of another vehicle Vx by the vehicle train 300 is avoided or reduced.

### 3-1-3. Fourth Travel Control Processing

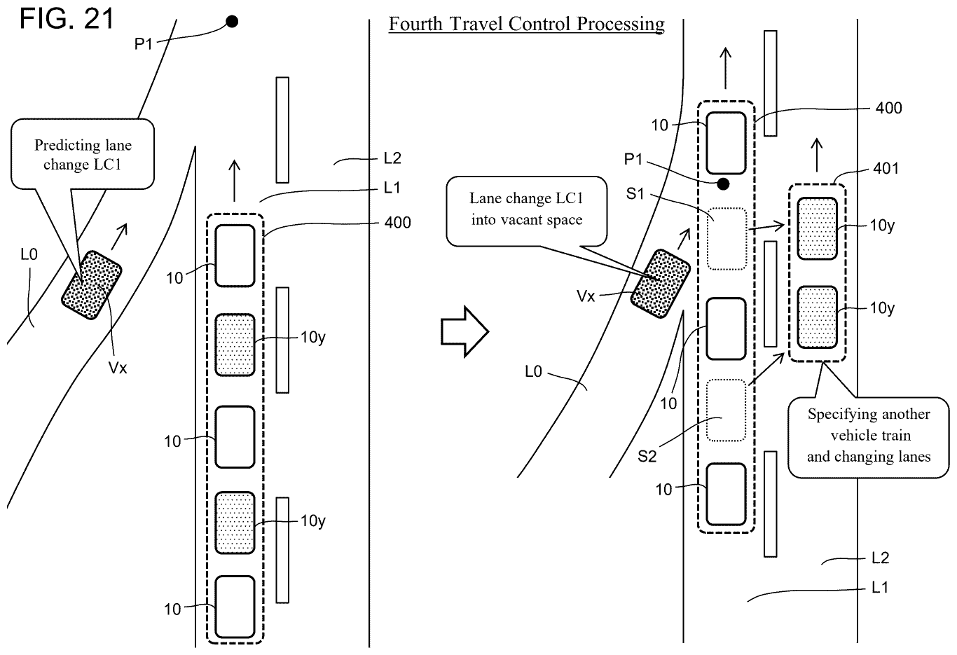

FIG. 21 is a diagram used to describe an example of the fourth travel control processing according to the present embodiment. In this example, when another vehicle Vx that is about to make a lane change LC1 is predicted, the management server 20 first specifies a plurality of specific vehicles 10y among the vehicles 10 included in a vehicle train 400 (support target vehicle train T). Each of the plurality of specific vehicles 10y has the travel preference information Ipv that is separated from the travel preference information Ipt of the vehicle train 400 by a designated threshold value or more. In other words, the management server 20 specifies, as the plurality of specific vehicles 10y, a plurality of vehicles 10 having the travel preference information Ipv close to an outlier with respect to the travel preference information Ipt of the vehicle train 400. To be more specific, the management server 20 specifies the plurality of specific vehicles 10y on the basis of, for example, a statistical value (for example, a variance, a deviation (for example, a standard deviation, a mean deviation)) of the travel preference information Ipv of each of the vehicles 10 read from the memory device 23.

Then, the management server 20 instructs each of the plurality of specific vehicles 10y to leave the vehicle train 400 and form another vehicle train 401. To be specific, the management server 20 specifies the vehicle train 401 newly constituted by the plurality of specific vehicles 10y. Further, the management server 20 instructs the specified vehicle train 401 to change the travel lane of the vehicle train 401 to the travel lane L2 adjacent to the travel lane L1 of the vehicle train 401 on the opposite side of the travel lane L0 of the vehicle Vx. In addition, the management server 20 updates the vehicle train information It to reflect information on the leaving of the plurality of specific vehicles 10y from the vehicle train 400 and the formation of the new vehicle train 401.

Even according to the fourth travel control processing described above, the impedance of the lane change LC1 of another vehicle Vx by the vehicle train 400 is avoided or reduced. To be more specific, according to the fourth travel control processing, the vehicle Vx can make the lane change LC1 more smoothly than when the fourth travel control processing is not performed, by using any one of spaces (for example, S1 and S2 in FIG. 21) vacated by a plurality of specific vehicles (for example, two specific vehicles) 10y and a space around the any one of spaces. Further, the formation of another vehicle train 401 is performed as described above in consideration of the travel preference information Ipt and Ipv. As a result, after the plurality of specific vehicles 10y leave, the lane change LC1 of the vehicle Vx can be facilitated while reconstituting the vehicle train 400 by the plurality of remaining vehicles 10 having closer travel preference information Ipv.

Furthermore, the specification of the plurality of vehicles 10y in the fourth travel control processing may be executed, more specifically, so as to specify a plurality of specific vehicles 10y having the travel preference information Ipv that is separated from the travel preference information Ipt of the vehicle train 400 “in the same direction” by a threshold value or more. Accordingly, the lane change LC1 of the vehicle Vx can be facilitated while constituting the another vehicle train 401 by the plurality of vehicles 10y having the travel preference information Ipv close to each other.

Additionally, after the vehicle Vx make the lane change LC1 using the space in the vehicle train 400 in association with the execution of the fourth travel control processing, the management server 20 may execute “vehicle train reconstitution processing” described below for the vehicle train 400 as necessary.

### 3-1-4. Examples of How to Select Second to Fourth Travel Control Processing

The instruction of the acceleration, the deceleration, or the lane change LC2 to the vehicle train 300 by the second travel control processing (the first, second, or third example described above) may be selected as follows, for example, on the basis of various kinds of information, such as the information on the travel speeds of the vehicle train 300 and another vehicle Vx, or the vehicle train surrounding situation information Its. That is, when the travel speed of the vehicle train 300 is higher than the travel speed of the vehicle Vx traveling in the travel lane L0, the management server 20 may select the instruction (the first example) for accelerating the vehicle train 300. On the other hand, when the travel speed of the vehicle Vx is higher than the travel speed of the vehicle train 300, the management server 20 may select the instruction (the second example) for decelerating the vehicle train 300. In addition, when the management server 20 determines that there is a sufficient travel space for the vehicle train 300 in the adjacent lane (travel lane L2) on the opposite side of the travel lane L0 of the vehicle Vx based on the vehicle train surrounding situation information Its (for example, information on availability (congestion) of the adjacent lane), the management server 20 may select the lane change LC2 (the third example).

Moreover, the instruction to divide the vehicle train 300 by the third travel control processing may be selected as follows, for example. That is, the management server 20 may determine whether or not another vehicle Vx can make a lane change LC1 without overlapping the vehicle train 300 by accelerating or decelerating at least one of the vehicle Vx and the vehicle train 300 based on, for example, the travel information (e.g., position and travel speed) of the vehicle Vx, the vehicle train travel information Itt (e.g., position and travel speed), and the map information. Then, when the management server 20 determines that the lane change LC1 is impossible even if the acceleration or deceleration is performed, the management server 20 may select the instruction to divide the vehicle train 300 into the vehicle trains 301 and 302. In addition, the instruction to form another vehicle train 401 for a plurality of specific vehicles 10y (the fourth travel control processing) may be selected similarly in accordance with the result of the determination described here.

Furthermore, the instruction to divide the vehicle train 300 by the third travel control processing may be selected as follows, for example. That is, the management server 20 determines whether or not the number of surrounding vehicles Vy traveling in the travel lane L1 of the vehicle train 300 within a designated distance range from the vehicle train 300 is equal to or greater than a designated threshold value, based on, for example, the vehicle train travel information Itt (e.g., position), the vehicle train surrounding situation information Its (for example, information on availability (congestion) of the travel lane L1) and the map information. Then, when the result of this determination is Yes, the management server 20 may select the instruction (the fourth example) for dividing the vehicle train 300 into the vehicle trains 301 and 302. As a result, even in a situation where it is difficult to secure the travel space Svx only by simply accelerating or decelerating the vehicle train 300 because there are many surrounding vehicles Vy traveling in the same travel lane L1 as the vehicle train 300, the vehicle train 300 can be caused to appropriately perform yield traveling in consideration of the vehicle Vx. In addition, the instruction to form another vehicle train 401 for a plurality of specific vehicles 10y (the fourth travel control processing) may be selected similarly in accordance with the result of the determination described here.

According to each of the second, third, and fourth travel control processing described above, it is possible to create a travel environment in which another vehicle Vx that is not managed by the management server 20 (central server) can also easily travel.

### 3-2. Vehicle Train Dissipation Processing

When a vehicle train is traveling in a row, a situation in which there is no point in maintaining the vehicle train anymore or a situation in which a disadvantage occurs due to the maintenance of the vehicle train may occur due to the travel environment of the vehicle train (for example, traffic density, traffic regulation, road shape). When this kind of situation occurs, in other words, when a condition for maintaining the vehicle train T (i.e., vehicle train maintenance condition C) is not satisfied, it is appropriate to autonomously dissipate the vehicle train.

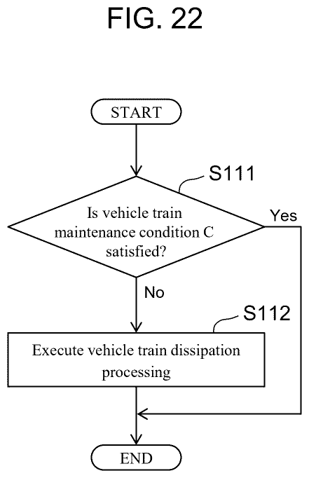

Accordingly, the management server 20 may execute the “vehicle train dissipation processing” as follows. FIG. 22 is a flowchart used to describe the vehicle train dissipation processing according to the present embodiment.

In step S111, the management server 20 determines whether or not the vehicle train maintenance condition C is satisfied based on travel environment information read from the memory device 23. The travel environment information mentioned here is information indicating the travel environment of the vehicle train T, and includes, for example, the vehicle train surrounding situation information Its (e.g., traffic density, traffic regulation, surrounding emergency vehicles), the vehicle train travel information Itt (e.g., travel speed), and the map information (e.g., road shape, number of lanes) that are described above. The vehicle train maintenance condition C is not satisfied as follows, for example.

That is, the vehicle train maintenance condition C may not be satisfied when the traffic density (i.e., vehicle density) of the road on which the vehicle train T is traveling exceeds a designated threshold value. More specifically, the management server 20 calculates a statistical value (for example, a mean value) of the traffic density in a designated time range at or before the current time based on, for example, the travel environment information (traffic density). Then, when this statistical value exceeds a predetermined threshold value, the management server 20 determines that the vehicle train maintenance condition C is not satisfied. In addition, the traffic density (number of vehicles/km) may be replaced with a traffic volume (number of vehicles/hour).

Moreover, the vehicle train maintenance condition C may not be satisfied when the travel speed of the vehicle train T decreases to a designated threshold value or less due to the travel environment. More specifically, the management server 20 calculates a statistical value (for example, a mean value) of the travel speed of the vehicle train T in a designated time range at or before the current time based on, for example, the travel environment information (the travel speed of the vehicle train T). Then, when this statistical value exceeds a predetermined threshold value, the management server 20 determines that the vehicle train maintenance condition C is not satisfied.

Moreover, the vehicle train maintenance condition C may not be satisfied when there is a traffic regulation ahead of the road on which the vehicle train T travels (for example, in bad weather or when a traffic accident occurs). The management server 20 can determine whether or not there is a traffic regulation based on, for example, the travel environment information (the vehicle train surrounding situation information Its).

Moreover, the vehicle train maintenance condition C may not be satisfied when an emergency vehicle (for example, an ambulance vehicle, a fire vehicle, or a police vehicle) is traveling in the vicinity of the vehicle train T. The management server 20 can determine the presence or absence of an emergency vehicle based on, for example, the travel environment information (the vehicle train surrounding situation information Its).

Moreover, the vehicle train maintenance condition C may not be satisfied when the number of lanes on the road on which the vehicle train T travels will decrease to one or has decreased to one. The management server 20 can determine whether or not the number of lanes will decrease to one or has decreased to one based on, for example, the travel environment information (for example, the vehicle train travel information Itt and the map information).

Furthermore, the vehicle train maintenance condition C may not be satisfied when the shape of the road on which the vehicle train T travels is not suitable or becomes unsuitable for the platooning. The management server 20 can determine whether or not the road shape is not suitable or becomes unsuitable for the platooning based on, for example, the travel environment information (for example, the vehicle train travel information Itt and the map information).

When the vehicle train maintenance condition C is satisfied (step S111; Yes), the processing proceeds to “END”. On the other hand, when the vehicle train maintenance condition C is not satisfied (step S111; No), the processing proceeds to step S112. In step S112, the management server 20 transmits an instruction for ending the platooning (that is, an instruction for dissipating the vehicle train T) to each of the vehicles 10 included in the vehicle train T (vehicle train dissipation processing).

Specifically, when the vehicles 10 that are targets of the instruction are manually driven vehicles (including the driving assistance vehicles described above), the management server 20 requests the occupant 2 of each of the vehicles 10 to end the platooning (that is, to leave the vehicle train T) by using the notification to the HMI device 15. Also, when the vehicles 10 that are targets of the instruction are automated driving vehicles, the management server 20 remotely controls each of the vehicles 10 so as to leave the vehicle train T and perform the automated driving independently in order to end the platooning. More specifically, the management server 20 instructs the control device 14 of each vehicle 10 to perform the automated driving independently. Alternatively, the management server 20 directly controls the travel device 13 of each vehicle 10 to perform the automated driving independently. According to the vehicle train dissipation processing described above, it is possible to prevent the presence of the vehicle train T from adversely affecting the traffic flow.

### 3-3. Vehicle Train Reconstitution Processing

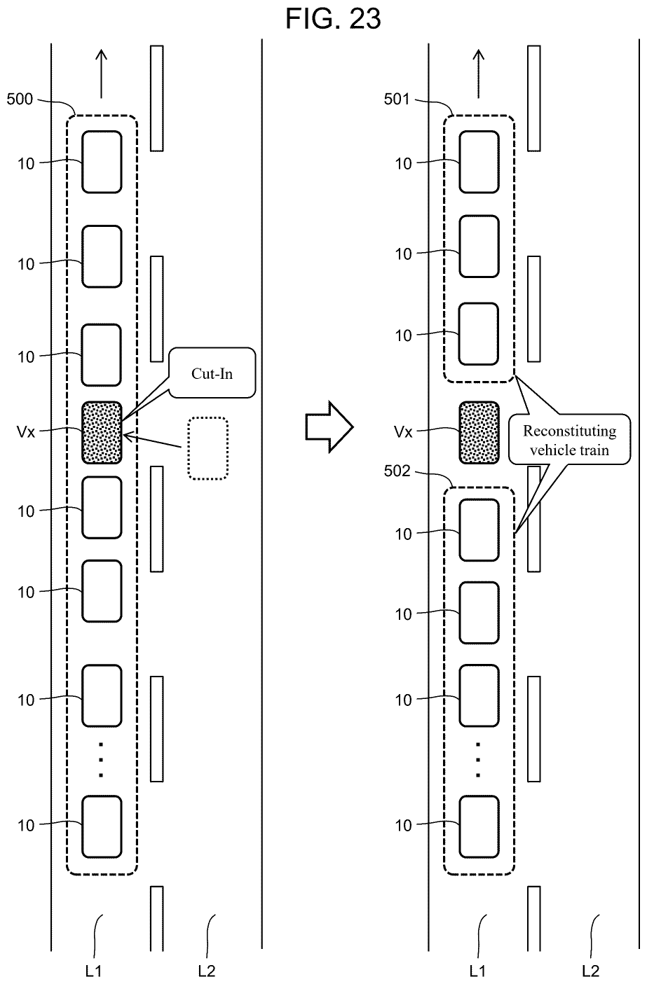

FIG. 23 is a diagram used to describe another issue during traveling of the support target vehicle train T and the vehicle train reconstitution processing as a countermeasure against the another issue. There is a possibility that another vehicle may cut into a vehicle train that is traveling in a row. FIG. 23 illustrates a vehicle train 500 in which a cut-in by another vehicle Vx traveling in the travel lane L2 adjacent to the travel lane L1 of the vehicle train 500 (support target vehicle train T) has occurred. When another vehicle Vx cuts into from the outside of the vehicle train 500 as described above, it is not possible to maintain the single vehicle train 500 formed by a plurality of vehicles 10 having the travel preference information Ipv close to each other.

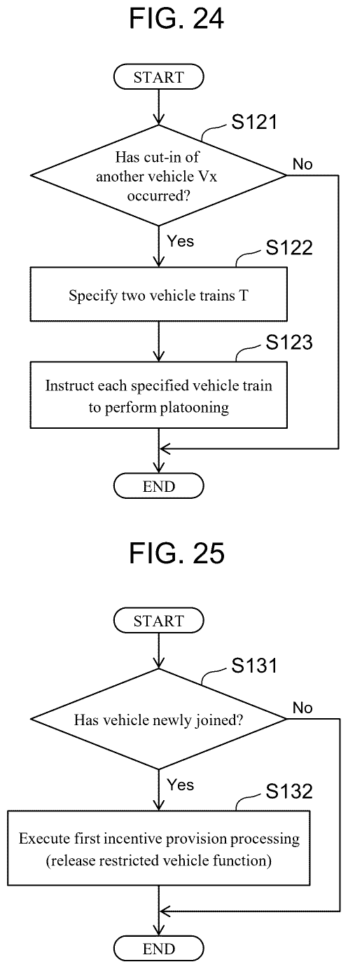

Accordingly, the management server 20 may execute the “vehicle train reconstitution processing” as follows. FIG. 24 is a flowchart used to describe the vehicle train reconstitution processing according to the present embodiment.

In step S121, the management server 20 determines whether or not a cut-in of another vehicle Vx with respect to the vehicle train 500 has occurred. The management server 20 can recognize the occurrence of the cut-in of the vehicle Vx using the sensor group 12 (recognition sensor) of a constituent vehicle 10 of the vehicle train 500, for example. When the cut-in of the vehicle Vx does not occur (step S121; No), the processing proceeds to “END”. On the other hand, when the cut-in has occurred (step S121; Yes), the processing proceeds to step S122.

In step S122, the management server 20 specifies two vehicle trains T (for example, vehicle trains 501 and 502 (see FIG. 23)) based on, for example, the vehicle train travel information Itt (the position information of the vehicles 10 included in the vehicle train T) and the position information of the vehicle Vx. The vehicle trains 501 and 502 correspond to examples of the “third vehicle train” and the “fourth vehicle train” according to the present disclosure, respectively. That is, the vehicle train 502 is formed by one or more vehicles 10 located ahead of the vehicle Vx among the plurality of vehicles 10 included in the vehicle train 500. The vehicle train 502 is formed by one or more vehicles 10 located behind the vehicle Vx among the plurality of vehicles 10 included in the vehicle train 500. In addition, the management server 20 updates the vehicle train information It so as to reflect information on the dissipation of the vehicle train 500 and the formation of the new vehicle trains 501 and 502.

In step S123 subsequent to step S122, the management server 20 instructs each of the specified vehicle trains T (for example, the vehicle trains 501 and 502) to perform the platooning as one vehicle train. That is, the management server 20 instructs the vehicle 10 included in the vehicle train 501 (more specifically, each vehicle 10 or the lead vehicle 10) to perform the platooning as the vehicle train 501. Similarly, the management server 20 instructs the vehicle 10 included in the vehicle train 502 (more specifically, each vehicle 10 or the lead vehicle 10) to perform the platooning as the vehicle train 502.

Additionally, the management server 20 may notify the occupant 2 of each vehicle 10 included in the vehicle trains 501 and 502 of information indicating that the vehicle train T to which the subject vehicle 10 belongs has been updated, via the HMI device 15 of the each vehicle 10.

According to the vehicle train reconstitution processing described above, even when another vehicle Vx cuts into a vehicle train T, the vehicle train T can be reconstituted into small units and the occupant 2 of each of the constituent vehicles 10 can continue to receive an incentive for forming the vehicle train T.

### 3-4. Incentive Provision Processing

There may be a merit in the entire road or the entire society by forming a vehicle train. However, if the incentive felt by each vehicle is weak, it is difficult to increase the motivation of the occupant of each vehicle to join the vehicle train. As a result, the vehicle train itself is less likely to be formed. This may miss out on benefits for society as a whole.

### 3-4-1. First Incentive Provision Processing

Accordingly, the management server 20 may execute the “first incentive provision processing” as follows. FIG. 25 is a flowchart used to describe the first incentive provision processing according to the present embodiment.

In step S131, the management server 20 determines whether or not a vehicle 10 has newly joined the vehicle train T based on, for example, the vehicle train information It and the map information. When the vehicle 10 newly joins the vehicle train T, the vehicle train information It is updated (see step S14). Therefore, the management server 20 can determine whether or not a new vehicle 10 has joined the vehicle train T based on the vehicle train information It. When a new vehicle 10 does not join (step S131; No), the processing proceeds to “END”. On the other hand, when a new vehicle 10 joins (step S131; Yes), the processing proceeds to step S132.

In step S132, the management server 20 executes processing (first incentive provision processing) of releasing a “vehicle function F”, which is restricted during non-execution of the platooning from being used by the vehicle 10 that has joined the vehicle train T, to the vehicle 10 only during execution of the platooning. As a premise, each vehicle 10 that communicates with the management server 20 is configured to be able to switch between restriction and release (that is, invalidation of the restriction) of the vehicle function F in response to an instruction from the management server 20.

The vehicle function F may include, for example, an automated driving function (including a driving assistance function for supporting driving of the occupant 2 (driver)). The automated driving function may be provided by, for example, the control device 14 that controls the travel device 13 using the sensor group 12. Also, the automated driving function released by the first incentive provision processing may be, for example, a higher-level function (e.g., a hands-off function or an eyes-off function) of an advanced driving assistance system included in the vehicle 10.

Moreover, the vehicle 10 may include a seat having a function of massaging the occupant 2. Also, the vehicle function F released by the first incentive provision processing may include the massage function, for example.

Furthermore, the HMI device 15 or one or more other in-vehicle devices mounted on the vehicle 10 may include at least one of a meter display function, an audio function, and a media playback function. Also, the vehicle functions F released by the first incentive provision processing may include, for example, at least one of a specific meter display function, a specific audio function, and a specific media playback function (e.g., a media playback function such as viewing a video (for example, a movie) or a moving image at the time of the eyes off).

### 3-4-2. Second Incentive Provision Processing

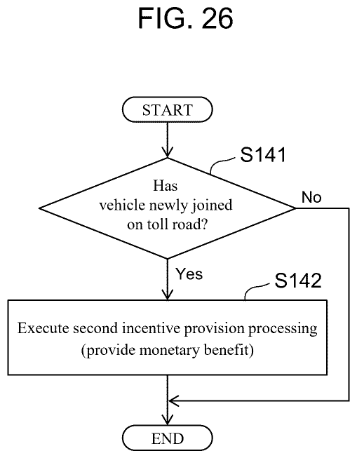

The management server 20 may execute the “second incentive provision processing” as follows, instead of or in addition to the first incentive provision processing. FIG. 26 is a flowchart used to describe the second incentive provision processing according to the present embodiment.

In step S141, the management server 20 determines whether or not a vehicle 10 has newly joined the vehicle train T on a toll road (e.g., an expressway) based on, for example, the vehicle train information It and the map information. As a result, when a new vehicle 10 does not join (step S141; No), the processing proceeds to “END”. On the other hand, when a new vehicle 10 joins (step S141; Yes), the processing proceeds to step S142.

In step S142, the management server 20 executes processing (second incentive provision processing) of providing the occupant 2 of a vehicles 10 that has joined the vehicle train T on the toll road with a “monetary benefit” associated with the use of the toll road.

Specifically, the provision of the monetary benefit to the occupant 2 may include, for example, discounting the usage fee of the toll road of the vehicle 10 that has joined the vehicle train T. More specifically, for example, the discount of the usage fee of the toll road may be performed in accordance with the travel distance of the vehicle 10 during the platooning or may be a discount of the fee of the travel section by the platooning. Further, the provision of the monetary benefit may include a discount on a periodic usage fee of a toll road for a designated period (for example, one month, three months, or six months) on the assumption that the vehicle 10 travels in a vehicle train. Furthermore, the monetary benefit may be provided as a coupon or a point provided in association with the execution of the platooning on a toll road, for example. More specifically, the coupon may be issued, for example, in response to one platooning on a toll road, to discount the usage fee for the next platooning. For example, the point may be given each time the vehicle 10 travels in a vehicle train on a toll road and may have a monetary value that can be used to pay a toll for the toll road.

According to each of the first incentive provision processing and the second incentive provision processing described above, it is possible to favorably increase the incentive to the occupant 2 of each vehicle 10 for forming the “support target vehicle train T” (in other words, the motivation of the occupant 2 for each vehicle 10 to form the vehicle train T).

Additionally, in each of the first incentive provision processing and second incentive provision processing, “the vehicle 10 that has joined the vehicle train T” includes not only the vehicle 10 that has newly joined the vehicle train T that has already been formed by a plurality of vehicles 10, but also one of two or more vehicles 10 that initially form the vehicle train T.

What is claimed is:

1. A travel support device that supports platooning of a plurality of vehicles, comprising processing circuitry configured to:
acquire travel preference information indicating a preference of an occupant regarding vehicle traveling, from each of the plurality of vehicles;
based on the travel preference information, execute vehicle train formation support processing of supporting formation of a support target vehicle train in which vehicles having similar preferences perform the platooning; and
when there is a plurality of support target vehicle trains, execute first travel control processing of acquiring at least one of the travel preference information and vehicle train travel information from each of the plurality of support target vehicle trains and controlling the platooning of each of the plurality of support target vehicle trains based on the acquired at least one of the travel preference information and the vehicle train travel information.

2. The travel support device according to claim 1, wherein
after predicting another vehicle that is about to make a lane change to a travel lane of the support target vehicle train, the processing circuitry executes second travel control processing of instructing the support target vehicle train to accelerate, decelerate, or change lanes so as not to impede the lane change of the another vehicle.

3. The travel support device according to claim 1, wherein
after predicting another vehicle that is about to make a lane change to a travel lane of the support target vehicle train, the processing circuitry executes third travel control processing, and
the third travel control processing includes:
specifying first and second vehicle trains acquired by dividing the support target vehicle train in such a manner as not to impede the lane change of the another vehicle; and
instructing the support target vehicle train to form the first and second vehicle trains while securing a travel space for the another vehicle between the first vehicle train and the second vehicle train.

4. The travel support device according to claim 1, wherein
after predicting another vehicle that is about to make a lane change to a travel lane of the support target vehicle train, the processing circuitry executes fourth travel control processing, and
the fourth travel control processing includes:
specifying a plurality of specific vehicles among vehicles included in the support target vehicle train, wherein the plurality of specific vehicles each have the travel preference information that is different from the travel preference information of the support target vehicle train by a threshold value or more; and
instructing each of the plurality of specific vehicles to cause the plurality of specific vehicles to leave the support target vehicle train and form another vehicle train.

5. The travel support device according to claim 1, wherein
the processing circuitry executes vehicle train dissipation processing, and
the vehicle train dissipation processing includes:
based on travel environment information on the support target vehicle train, determining whether or not a vehicle train maintenance condition for maintaining the support target vehicle train is satisfied; and
transmitting an instruction for ending the platooning to the support target vehicle train when the vehicle train maintenance condition is not satisfied.

6. The travel support device according to claim 1, wherein
after another vehicle cuts into the support target vehicle train, the processing circuitry executes vehicle train reconstitution processing, and
the vehicle train reconstitution processing includes:
specifying a third vehicle train formed by one or more vehicles located ahead of the another vehicle among vehicles included in the support target vehicle train and a fourth vehicle train formed by one or more vehicles located behind the another vehicle among the vehicles included in the support target vehicle train;
instructing the third vehicle train to perform platooning as the third vehicle train; and
instructing the fourth vehicle train to perform platooning as the fourth vehicle train.

7. The travel support device according to claim 1, wherein
after a first vehicle joins the support target vehicle train, the processing circuitry executes processing of releasing a vehicle function which is restricted during non-execution of the platooning from being used by the first vehicle that has joined, to the first vehicle only during execution of the platooning.

8. The travel support device according to claim 1, wherein
after a second vehicle joins the support target vehicle train on a toll road, the processing circuitry executes processing of providing a monetary benefit associated with use of the toll road to an occupant of the second vehicle that has joined.

9. The travel support device according to claim 1, wherein
the travel preference information includes at least one of travel pattern preference information on a desired travel pattern, destination preference information on a desired destination, and travel speed preference information on a desired travel speed.

10. The travel support device according to claim 1, wherein
the travel preference information includes travel speed preference information on a desired travel speed,
the plurality of support target vehicle trains include a preceding vehicle train and a following vehicle train having a desired travel speed higher than that of the preceding vehicle train, and
the first travel control processing includes instructing the preceding vehicle train or the following vehicle train to make a lane change for causing the following vehicle train to move ahead of the preceding vehicle train when the following vehicle train approaches the preceding vehicle train.

11. The travel support device according to claim 1, wherein
the travel preference information includes travel pattern preference information on a desired travel pattern specified by at least a preference for a lane change frequency, and
the first travel control processing includes instructing a vehicle train that prefers a higher lane change frequency among a preceding vehicle train and a following vehicle train that are included in the plurality of support target vehicle trains to make a lane change for causing the following vehicle train to move ahead of the preceding vehicle train when the following vehicle train approaches the preceding vehicle train.

12. The travel support device according to claim 1, wherein
the travel preference information includes destination preference information including information on a remaining distance to a desired destination of a vehicle train, and
the first travel control processing includes instructing a vehicle train having a longer remaining distance among a preceding vehicle train and a following vehicle train that are included in the plurality of support target vehicle trains to make a lane change for causing the following vehicle train to move ahead of the preceding vehicle train when the following vehicle train approaches the preceding vehicle train.

13. The travel support device according to claim 1, wherein
the travel preference information includes travel pattern preference information on a desired travel pattern specified by at least a preference of a speed range, and
the first travel control processing includes instructing one vehicle train that prefers a wider speed range among a preceding vehicle train and a following vehicle train that are included in the plurality of support target vehicle trains to change a travel speed in accordance with a travel speed of another vehicle train among the preceding vehicle train and the following vehicle train when the following vehicle train approaches the preceding vehicle train.

14. The travel support device according to claim 1, wherein
the vehicle train travel information includes information on a number of vehicles forming a vehicle train, and
the first travel control processing includes instructing a vehicle train having a smaller number of vehicles among a preceding vehicle train and a following vehicle train that are included in the plurality of support target vehicle trains to make a lane change for causing the following vehicle train to move ahead of the preceding vehicle train when the following vehicle train approaches the preceding vehicle train.

15. The travel support device according to claim 1, wherein
the travel preference information includes travel pattern preference information on a desired travel pattern specified by at least a preference for a lane change frequency,
the vehicle train travel information includes information on a number of past lane changes as a vehicle train,
the plurality of support target vehicle train include a preceding vehicle train and a following vehicle train having a same preference of the lane change frequency as the preceding vehicle train, and
the first travel control processing includes instructing a vehicle train having a smaller number of past lane changes among the preceding vehicle train and the following vehicle train to make a lane change for causing the following vehicle train to move ahead of the preceding vehicle train when the following vehicle train approaches the preceding vehicle train.

16. A travel support method for supporting platooning of a plurality of vehicles, the travel support method, which is executed by a computer, comprising:
acquiring travel preference information indicating a preference of an occupant regarding vehicle traveling, from each of the plurality of vehicles;
based on the travel preference information, executing vehicle train formation support processing of supporting formation of a support target vehicle train in which vehicles having similar preferences perform the platooning; and
when there is a plurality of support target vehicle trains, executing first travel control processing of acquiring at least one of the travel preference information and vehicle train travel information from each of the plurality of support target vehicle trains and controlling the platooning of each of the plurality of support target vehicle trains based on the acquired at least one of the travel preference information and the vehicle train travel information.

17. A non-transitory computer-readable recording medium storing a travel support program executed by a computer for supporting platooning of a plurality of vehicles,
the travel support program causing the computer to execute:
acquiring travel preference information indicating a preference of an occupant regarding vehicle traveling, from each of the plurality of vehicles;
based on the travel preference information, executing vehicle train formation support processing of supporting formation of a support target vehicle train in which vehicles having similar preferences perform the platooning; and
when there is a plurality of support target vehicle trains, executing first travel control processing of acquiring at least one of the travel preference information and vehicle train travel information from each of the plurality of support target vehicle trains and controlling the platooning of each of the plurality of support target vehicle trains based on the acquired at least one of the travel preference information and the vehicle train travel information.
